(19) United States
(12) Patent Application Publication
(10) Pub. No.: US 2025/0376951 A1
(43) Pub. Date: Dec. 11, 2025

(54) ENGINE SYSTEM FOR AN AIRCRAFT

(71) Applicants: GE Avio S.r.l., Rivalta di Torino (IT); GE Aviation Czech s.r.o., Praha (CZ)

(72) Inventors: Simone Iurlaro, Torino (IT); Juraj Hrubec, Prague (CZ); Michele Gravina, Milano (IT); Andrea Piazza, Torino (IT); Daniele Pampalone, Torino (IT); Marco Sandrucci, Certaldo (IT)

(21) Appl. No.: 19/230,979

(22) Filed: Jun. 6, 2025

(30) Foreign Application Priority Data
Jun. 6, 2024 (IT) 102024000013096

(51) Int. Cl. F02C 7/36

(52) U.S. Cl. CPC F02C 7/36; F05D 2220/323; F05D 2220/324; F05D 2220/36; F05D 2260/40311

(57) ABSTRACT

An engine system for an aircraft includes a first turbofan engine and a second turbofan engine. The first turbofan engine includes a first low-pressure shaft, a first fan having a first fan shaft, and a counterclockwise gearbox assembly. The first fan shaft is drivingly coupled to the first low-pressure shaft through the counterclockwise gearbox assembly. The first low-pressure shaft rotates in a counterclockwise direction. The first fan shaft rotates in the counterclockwise direction such that the first fan rotates in the counterclockwise direction. The second turbofan engine includes a second low-pressure shaft, a second fan having a second fan shaft, and a clockwise gearbox assembly. The second fan shaft is drivingly coupled to the second low-pressure shaft through the clockwise gearbox assembly. The second low-pressure shaft rotates in the counterclockwise direction. The second fan shaft rotates in a clockwise direction such that the second fan rotates in the clockwise direction.

### CROSS REFERENCE TO RELATED APPLICATIONS

The present application claims the benefit of Italian Patent Application No. 102024000013096, filed on Jun. 6, 2025, which is hereby incorporated by reference herein in its entirety.

### TECHNICAL FIELD

The present disclosure relates generally to engine systems for aircraft.

### BACKGROUND

Engine systems for aircraft include one or more turbofan engines. Turbofan engines for an aircraft generally include a fan having fan blades and a turbo-engine arranged in flow communication with one another. Some turbofan engines include a gearbox assembly that transfers torque and power from the turbo-engine to the fan.

### BRIEF DESCRIPTION OF THE DRAWINGS

The foregoing and other features and advantages will be apparent from the following, more particular, description of various exemplary embodiments, as illustrated in the accompanying drawings, wherein like reference numbers generally indicate identical, functionally similar, or structurally similar elements.

FIG. 1 is a front schematic view of an aircraft having an engine system, according to the present disclosure.

FIG. 2 is a schematic cross-sectional view of a turbofan engine, taken along a longitudinal centerline axis of the turbofan engine, according to the present disclosure.

FIG. 3A is an elevational view showing a counterclockwise gearbox assembly for a turbofan engine, according to the present disclosure.

FIG. 3B is a schematic cross-sectional view of the counterclockwise gearbox assembly of FIG. 3A, taken along a longitudinal centerline axis of the counterclockwise gearbox assembly, according to the present disclosure.

FIG. 3C is an enlarged schematic cross-sectional view of the counterclockwise gearbox assembly of FIG. 3B, taken at detail 3C in FIG. 3B, according to the present disclosure.

FIG. 3D is an enlarged schematic front view of the counterclockwise gearbox assembly of FIG. 3A, taken at detail 3D in FIG. 3A, according to the present disclosure.

FIG. 4A is an elevational view showing a clockwise gearbox assembly for a turbofan engine, according to the present disclosure.

FIG. 4B is a schematic cross-sectional view of the clockwise gearbox assembly of FIG. 4A, taken along a longitudinal centerline axis of the counterclockwise gearbox assembly, according to the present disclosure.

FIG. 4C is an enlarged schematic cross-sectional view of the clockwise gearbox assembly of FIG. 4B, taken at detail 4C in FIG. 4B, according to the present disclosure.

FIG. 5 is a schematic cross-sectional view of a counterclockwise gearbox assembly, taken along a longitudinal centerline axis of the counterclockwise gearbox assembly, according to another embodiment.

### DETAILED DESCRIPTION

Features, advantages, and embodiments of the present disclosure are set forth or apparent from a consideration of the following detailed description, drawings, and claims. Moreover, the following detailed description is exemplary and intended to provide further explanation without limiting the scope of the disclosure as claimed.

Various embodiments of the present disclosure are discussed in detail below. While specific embodiments are discussed, this is done for illustration purposes only. A person skilled in the relevant art will recognize that other components and configurations may be used without departing from the present disclosure.

As used herein, the terms “first,” “second,” “third,” “fourth,” “fifth,” etc., may be used interchangeably to distinguish one component from another and are not intended to signify location or importance of the individual components.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “forward” and “aft” refer to relative positions within a turbofan engine or vehicle and refer to the normal operational attitude of the turbofan engine or the aircraft. For example, with regard to an aircraft, forward refers to a position closer to a nose of the aircraft and aft refers to a position closer to a tail of the aircraft. For a turbofan engine, forward refers to a position on the turbofan engine that is closer to the fan and aft refers to a position on the turbofan engine that is further away from the fan (towards the exhaust). When the turbofan engine is configured in a pusher configuration, the fan is positioned on an aft side of the turbofan engine such that forward refers to a position that is further away from the fan and aft refers to a position that is closer to the fan.

The terms “coupled,” “fixed,” “attached,” “connected,” and the like, refer to both direct coupling, fixing, attaching, or connecting, as well as indirect coupling, fixing, attaching, or connecting through one or more intermediate components or features, unless otherwise specified herein.

The singular forms “a,” “an,” and “the” include plural references unless the context clearly dictates otherwise.

As used herein, the terms “axial” and “axially” refer to directions and orientations that extend substantially parallel to a centerline of the aircraft or the turbofan engine. Moreover, the terms “radial” and “radially” refer to directions and orientations that extend substantially perpendicular to the centerline of the aircraft or the turbofan engine. In addition, as used herein, the terms “circumferential” and “circumferentially” refer to directions and orientations that extend arcuately about the centerline of the aircraft or the turbofan engine.

As used herein, a “turbo-engine” includes a compressor section, a combustion section, and a turbine section.

As used herein, a “turbofan engine” includes a turbo-engine and a fan that directs air into the turbo-engine, and rated for use in a regional aircraft, narrow body aircraft, or wide body aircraft. A turbofan engine rated for use on a regional aircraft will have a maximum takeoff thrust in a range of ten thousand pound-force to twenty thousand pound-force (10,000 lbf to 20,000 lbf). A turbofan engine rated for use on a narrow body aircraft will have a maximum takeoff thrust in a range of fifteen thousand pound-force to thirty thousand pound-force (15,000 lbf to 30,000 lbf). A turbofan engine rated for use on a wide body aircraft will have a maximum takeoff thrust in a range of forty thousand pound-force to one hundred ten thousand pound-force (40,000 lbf to 110,000 lbf).

As used herein, the term “ducted engine” means a turbofan engine with a fan casing or nacelle that circumferentially surrounds the fan.

As used herein, an “unducted fan engine” or an “open fan engine” means a turbofan engine without a fan casing or a nacelle surrounding the fan.

As used herein, “clockwise” or a “clockwise direction” is a direction of rotation when viewed from forward of the aircraft, the turbofan engine, or the gearbox assembly, that corresponds to a direction in which the hands of a clock rotate as viewed from forward of the clock.

As used herein, “counterclockwise” or a “counterclockwise direction” is a direction of rotation when viewed from forward of the aircraft, the turbofan engine, or the gearbox assembly, that corresponds to an opposite direction to that in which the hands of the clock rotate as viewed from forward of the clock. Counterclockwise is a rotation direction that is opposite clockwise.

As used herein, “gear ratio” is a ratio of a rotational speed of an input of the gearbox assembly to a rotational speed of an output of the gearbox assembly. In particular, the gear ratio is an absolute value of the rotational speed of the input to the rotational speed of the output.

As used herein, a “double gearbox assembly” is a gearbox assembly having two stages of gear assemblies. For example, the double gearbox assemblies detailed herein include a first stage gear assembly and a second stage gear assembly. The output of the first stage gear assembly is the input of the second stage gear assembly.

As used herein, the terms “low,” “mid” (or “mid-level”), and “high,” or their respective comparative degrees (e.g., “lower” and “higher”, where applicable), when used with compressor, combustor, turbine, shaft, fan, or turbofan engine components, each refers to relative pressures, relative speeds, relative temperatures, or relative power outputs within an engine unless otherwise specified. For example, a “low-power” setting defines the engine or the combustor configured to operate at a power output lower than a “high-power” setting of the engine or the combustor, and a “mid-level power” setting defines the engine or the combustor configured to operate at a power output higher than a “low-power” setting and lower than a “high-power” setting. The terms “low,” “mid” (or “mid-level”) or “high” in such aforementioned terms may additionally, or alternatively, be understood as relative to minimum allowable speeds, pressures, or temperatures, or minimum or maximum allowable speeds, pressures, or temperatures relative to normal, desired, steady state, etc., operation of the engine. A mission cycle for a turbofan engine includes, for example, a low-power operation, a mid-level power operation, and a high-power operation. Low-power operation includes, for example, engine start, idle, taxiing, and approach. Mid-level power operation includes, for example, cruise. High-power operation includes, for example, takeoff and climb.

The various power levels of the turbofan engine are defined as a percentage of a sea level static (SLS) maximum engine rated thrust. Low power operation includes, for example, less than thirty percent (30%) of the SLS maximum engine rated thrust of the turbofan engine. Mid-level power operation includes, for example, thirty percent (30%) to eighty-five percent (85%) of the SLS maximum engine rated thrust of the turbofan engine. High power operation includes, for example, greater than eighty-five percent (85%) of the SLS maximum engine rated thrust of the turbofan engine. The values of the thrust for each of the low power operation, the mid-level power operation, and the high power operation of the turbofan engine are exemplary only, and other values of the thrust can be used to define the low power operation, the mid-level power operation, and the high power operation.

As used herein, “cruise,” “cruise conditions,” or “cruise speed” refers to operation of a turbine engine utilized to power an aircraft that may operate at a cruising speed when the aircraft levels in altitude after climbing to a specified altitude. A turbine engine may operate at a cruising speed that is from 50% to 90% of a rated speed of the turbine engine, such as from 70% to 80% of the rated speed. In some embodiments, a cruising speed may be achieved at about 80% of full throttle, such as from about 50% to about 90% of full throttle, such as from about 70% to about 80% full throttle. As used herein, the term “cruise flight” refers to a phase of flight in which an aircraft levels in altitude after a climb phase and prior to descending to an approach phase. In various examples, cruise flight may take place at a cruise altitude up to approximately 65,000 ft. In certain examples, cruise altitude is between approximately 28,000 ft. and approximately 45,000 ft. In yet other examples, cruise altitude is expressed in flight levels (FL) based on a standard air pressure at sea level, in which cruise flight is between FL280 and FL650. In another example, cruise flight is between FL280 and FL450. In still certain examples, cruise altitude is defined based at least on a barometric pressure, in which cruise altitude is between approximately 4.85 psia and approximately 0.82 psia based on a sea-level pressure of approximately 14.70 psia and sea-level temperature at approximately 59 degrees Fahrenheit. In another example, cruise altitude is between approximately 4.85 psia and approximately 2.14 psia. In certain examples, the ranges of cruise altitude defined by pressure may be adjusted based on a different reference sea-level pressure, a sea-level temperature, or both.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” “generally,” and “substantially” is not to be limited to the precise value specified. In at least some instances, the approximating language may correspond to the precision of an instrument for measuring the value, or the precision of the methods or the machines for constructing the components and/or the systems or manufacturing the components and/or the systems. For example, the approximating language may refer to being within a one, a two, a four, a ten, a fifteen, or a twenty percent margin in either individual values, range(s) of values and/or endpoints defining range(s) of values.

Here and throughout the specification and claims, range limitations are combined, and interchanged. Such ranges are identified and include all the sub-ranges contained therein unless context or language indicates otherwise. For example, all ranges disclosed herein are inclusive of the endpoints, and the endpoints are independently combinable with each other.

The present disclosure provides for an engine system that includes turbofan engines, and, particularly, includes open fan engines. The engine system includes two open fan engines including a first open fan engine mounted on a first side of an aircraft and a second open fan engine mounted on a second side of the aircraft. Turbofan engines typically have a uniform design such that the fan of the turbofan engine rotates in the same direction between two turbofan engines. This is referred to as an asymmetric configuration. The fans on both sides of the aircraft rotate in the same direction in the asymmetric configuration. Accordingly, the fan rotation of the two turbofan engines result in an undesired change in a yaw of the aircraft towards the rotation direction of the fans. This could result in an additional 1% fuel burn of the turbofan engines due to the need to correct the change in the yaw, and an additional two effective perceived noise in decibels (EPNdB) community noise due to the additional fuel burn.

The open fan engines have a gearbox assembly, also referred to as a power gearbox, that transfers power from a turbine shaft of the turbofan engine to a fan (e.g., a fan shaft or a propeller shaft). Such turbofan engines are referred to as indirect drive engines. Indirect drive engines differ from direct drive engines that directly couple the fan shaft to the turbine shaft without the use of a gearbox. The fan of direct drive engines rotates at a same speed as the turbine shaft. The fan of indirect drive engines, however, rotates at a lower speed than the turbine shaft due to the reduction of speed through the power gearbox.

Some turbofan engines have a variable pitch fan. Such engines include a fan pitch actuation system that includes one or more actuators for changing a pitch angle of fan blades of the variable pitch fan. The fan pitch actuation system typically includes a hydraulic system that supplies hydraulic fluid to one or more chambers to actuate the actuators. The actuators are coupled to the fan blades and actuation of the actuators causes the fan blades to rotate about a pitch axis P to change the pitch angle of the fan blades.

Some gearbox assemblies and fan actuation systems are designed for turboprop engines that include a propeller, rather than a fan. Turboprop engines produce less thrust than turbofan engines. Turboprop engines typically provide cruise speeds for an aircraft with a Mach number that is less than 0.7 and have fewer than ten propeller blades, such as fewer than eight propeller blades or fewer than five propeller blades. Turbofan engines include ten or more fan blades that extend from a disk and provide cruise speeds for an aircraft with a Mach number that is 0.7 or greater. To achieve these higher speeds, the fan aerodynamics for the turbofan engines are different than the propeller aerodynamics for turboprop engines, resulting in the turbofan engines having more fan blades for aerodynamic efficiency at higher Mach speeds. Turbofan engines with variable pitch fan blades also benefit from guide vanes, such as outlet guide vanes behind the fan blades, and/or inlet guide vanes forward of the fan, to reduce losses at higher speeds.

The available space, the desirable space, or the volume in that part of the engine for the higher-load-carrying fan pitch actuation system and gearbox assembly of a turbofan engine is not correspondingly larger than the space available for the lower-load-carrying fan pitch actuation system and the gearbox assembly of a turboprop. The available space in that part of the turbofan engine cannot be simply scaled up without affecting other components of the turbofan engine. For example, increasing the size of the space in that part of the engine affects the overall length of the turbofan engine, the fan radius ratio of the fan, the fan diameter of the fan, or a combination thereof. As turbofan engines have less available space, the fan pitch actuation system supply lines cannot be routed around the gearbox assembly without making the available space larger, thereby affecting the other components of the turbofan engine.

The gear ratio of the gearbox assembly in turboprops is greater than the gear ratio of the gearbox assembly in turbofan engines due to the lower speeds of the propeller of the turboprop compared to the speeds of the fan of the turbofan engines. In particular, the turboprops require a greater reduction in speed from the turbo-engine to the propeller through the gearbox assembly as compared to turbofan engines. Typically, turboprops require a gear ratio of greater than 14:1, while turbofan engines require a gear ratio of less than 14:1. Turboprop gearboxes typically utilize planet gears with journal bearings in a planetary configuration in which the planet gears rotate about the centerline axis of the gearbox to achieve a clockwise rotation of the propeller. The gearboxes for turbofan engines cannot simply scale up the turboprop gearbox configurations due to the higher loads or higher torques of the turbofan engines as compared to the loads and torques of the turboprop engines. In particular, the planet gears would need to be smaller in a turbofan gearbox in the planetary configuration to achieve the lower gear ratios as compared to the planet gears of the turboprop gearbox. However, the smaller planet gears would be unable to withstand the higher loads and the higher torques of the turbofan engine. Further, if the turbofan gearbox utilized journal bearings, the higher speeds through the gearbox would suck out the lubricant from the journal bearings, resulting in metal-to-metal contact between the planet gears and the planet pins.

Accordingly, the present disclosure provides for an engine system having two counter-rotating fans on the aircraft such that the first turbofan engine has a fan that rotates counterclockwise and the second turbofan engine has a fan that rotates clockwise. Such an engine system provides for a symmetric configuration such that the fans eliminate the undesired change of the yaw of the aircraft. To achieve the counter-rotating fans, the turbofan engines have a double gearbox assembly that each includes a first stage gear assembly and a second stage gear assembly. The output of the first stage gear assembly is an input of the second stage gear assembly such that the first stage gear assembly drives the second stage gear assembly. Particularly, the first stage gear assembly of each of the gearbox assemblies is in a star configuration in which the planet gears are held stationary with respect to the centerline axis of the gearbox and the ring gear drives the output. The input and the output of the star configuration are both in the same direction (e.g., the counterclockwise direction). The second stage gear assembly of the first turbofan engine is in a star configuration such that the output of the second stage gear assembly is in the counterclockwise direction. In this way, the fan of the first turbofan engine rotates in the counterclockwise direction. The second stage gear assembly of the second turbofan engine is in a planetary configuration in which the planet gears rotate about the centerline axis of the gearbox and the ring gear is held stationary such that the output of the second stage gear assembly is in the clockwise direction. In this way, the fan of the second turbofan engine rotates in the clockwise direction. Thus, the turbofan engines are counter-rotating in which the fan of the first turbofan engine rotates in the counterclockwise direction and the fan of the second turbofan engine rotates in the clockwise direction.

Such a configuration allows both turbofan engines to have the same input rotational direction (e.g., counterclockwise) while having different output rotational directions (e.g., counterclockwise on one engine and clockwise on the other engine). The double gearbox configuration of the present disclosure provides for reducing a radial envelope (radial extent) of the gearbox assembly as compared to gearbox assemblies that achieve a particular output rotational direction by other means, such as, for example, the use of idler gears. In this way, the double gearbox configuration of the present disclosure helps to maximize a size of the core flowpath of the turbine engine as compared to turbine engines without the benefit of the present disclosure. Further, the engine system of the present disclosure reduces the fuel burn and noise as compared to the asymmetric configuration. Further, the star configuration of the first stage gear assembly (stationary planet gears) allows the fan pitch actuation system supply lines to be routed through the gearbox assembly (through the planet carrier of the first stage gear assembly) to fit within the available space of the turbofan engine. Further, the gearbox assemblies achieve a gear ratio less than or equal to 14:1 (e.g., 6:1 to 14:1) by using the star configuration, which allows for larger planet gears as compared to the planetary configuration of turboprop engines to withstand the higher loads and the higher torques as compared to turboprop engines.

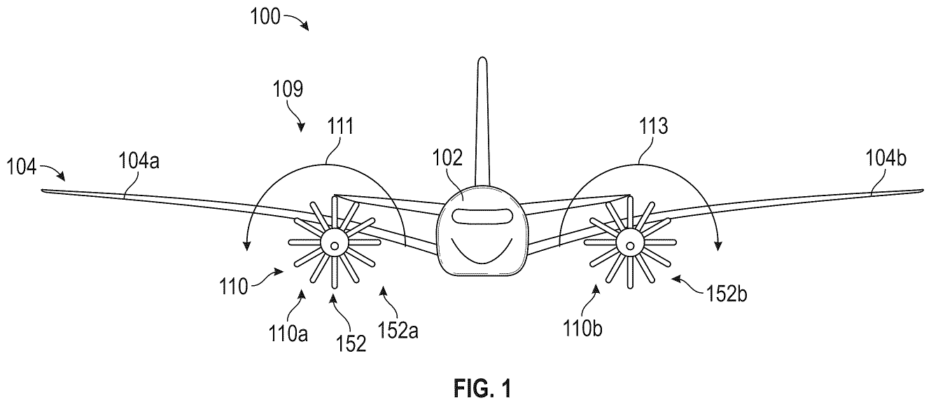

Referring now to the drawings, FIG. 1 is a front schematic view of an aircraft 100 having an engine system 109, according to the present disclosure. As shown in FIG. 1, the aircraft 100 includes a fuselage 102 and a plurality of wings 104 coupled to the fuselage 102. The plurality of wings 104 includes a first wing 104a and a second wing 104b. The aircraft 100 is exemplary only and can include any type of aircraft 100 having the engine system 109 detailed herein.

The engine system 109 includes a plurality of turbofan engines 110 including a first turbofan engine 110a and a second turbofan engine 110b. The plurality of turbofan engines 110 is mounted to the aircraft 100, particularly, mounted to the plurality of wings 104. Specifically, the first turbofan engine 110a is mounted to the first wing 104a and the second turbofan engine 110b is mounted to the second wing 104b. The plurality of turbofan engines 110 is suspended beneath the plurality of wings 104 in an under-wing configuration. Alternatively, however, in other exemplary embodiments, any other suitable aircraft engine configuration may be provided (e.g., over-wing configuration).

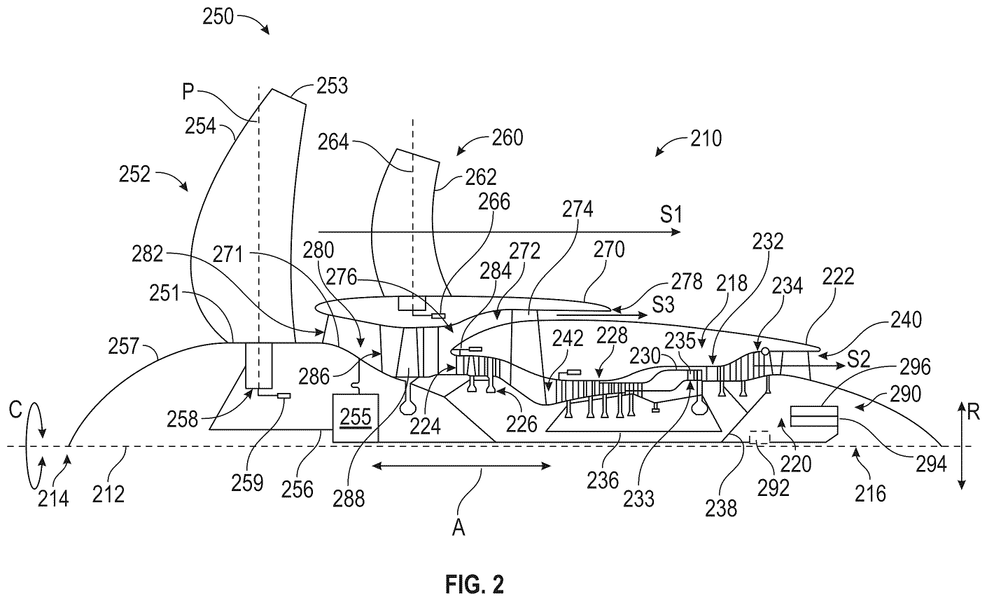

The plurality of turbofan engines 110 includes open-fan turbofan engines that each has a fan 152 that is unducted. In this way, the plurality of turbofan engines 110 does not include a fan casing or a nacelle that surrounds the fan 152. An exemplary open-fan turbofan engine is detailed further below with respect to FIG. 2. The first turbofan engine 110a includes a first fan 152a and the second turbofan engine 110b includes a second fan 152b. As detailed further below, the first turbofan engine 110a is configured such that the first fan 152a rotates in a first direction 111 and the second turbofan engine 110b is configured such that the second fan 152b rotates in a second direction 113. The second direction 113 is opposite the first direction 111. In particular, the first direction 111 is a counterclockwise direction and the second direction 113 is a clockwise direction. In the view of FIG. 1, the first turbofan engine 110a is mounted on a left side of the aircraft 100 and the second turbofan engine 110b is mounted on a right side of the aircraft 100. Thus, the first fan 152a (counterclockwise rotation) and the second fan 152b (clockwise rotation) rotate away from the fuselage 102 in an up-up configuration. In some embodiments, the first fan 152a rotates clockwise and the second fan 152b rotates counterclockwise such that the first fan 152a and the second fan 152b rotate toward the fuselage 102 in a down-down configuration.

FIG. 2 is a schematic cross-sectional view of a turbofan engine 210, taken along a longitudinal centerline axis 212 of the turbofan engine 210, according to the present disclosure. The turbofan engine 210 can be utilized as one of the plurality of turbofan engines 110 (the first turbofan engine 110a and the second turbofan engine 110b) of FIG. 1. The turbofan engine 210 is an unducted fan engine or an open fan engine. The turbofan engine 210 is a “three-stream engine” in that its architecture provides three distinct streams (labeled S1, S2, and S3) of thrust-producing airflow during operation, as detailed further below.

As shown in FIG. 2, the turbofan engine 210 defines an axial direction A, a radial direction R, and a circumferential direction C. The longitudinal centerline axis 212 extends along the axial direction A. In general, the axial direction A extends parallel to the longitudinal centerline axis 212, the radial direction R extends outward from, and inward to, the longitudinal centerline axis 212 in a direction orthogonal to the axial direction A, and the circumferential direction C extends three hundred sixty degrees (360°) around the longitudinal centerline axis 212. The turbofan engine 210 extends between a forward end 214 and an aft end 216, e.g., along the axial direction A.

The turbofan engine 210 includes a turbo-engine 220 and a fan assembly 250 positioned upstream thereof. Generally, the turbo-engine 220 includes a compressor section, a combustion section, a turbine section, and an exhaust section. Particularly, as shown in FIG. 2, the turbo-engine 220 includes an engine core 218 and a core cowl 222 that annularly surrounds the turbo-engine 220. The turbo-engine 220 and the core cowl 222 define a core inlet 224 having an annular shape that is annular about the longitudinal centerline axis 212. The core cowl 222 further encloses and supports a low-pressure (LP) compressor 226 (also referred to as a booster) for pressurizing the air that enters the turbo-engine 220 through the core inlet 224. A high-pressure (HP) compressor 228 receives pressurized air from the LP compressor 226 and further increases the pressure of the air. The pressurized air flows downstream to a combustor 230 where fuel is injected into the pressurized air and ignited to raise the temperature and the energy level of the pressurized air, thereby generating combustion gases.

The combustion gases flow from the combustor 230 downstream to a high-pressure (HP) turbine 232. The HP turbine 232 drives the HP compressor 228 through a first shaft, also referred to as a high-pressure (HP) shaft 236 (also referred to as a “high-speed shaft”). In this regard, the HP turbine 232 is drivingly coupled with the HP compressor 228. Together, the HP compressor 228, the combustor 230, and the HP turbine 232 define the engine core 218. The combustion gases then flow to a power turbine or a low-pressure (LP) turbine 234. The LP turbine 234 drives the LP compressor 226 and components of the fan assembly 250 through a second shaft, also referred to as a low-pressure (LP) shaft 238 (also referred to as a “low-speed shaft”). In this regard, the LP turbine 234 is drivingly coupled with the LP compressor 226 and components of the fan assembly 250. The LP shaft 238 is coaxial with the HP shaft 236 in the embodiment of FIG. 2. After driving each of the HP turbine 232 and the LP turbine 234, the combustion gases exit the turbo-engine 220 through a core exhaust nozzle 240. The turbo-engine 220 defines a core flowpath, also referred to as a core duct 242, that extends between the core inlet 224 and the core exhaust nozzle 240. The core duct 242 is an annular duct positioned generally inward of the core cowl 222 along the radial direction R.

The fan assembly 250 includes a fan 252 (e.g., the first fan 152a or the second fan 152b of FIG. 1), also referred to as a primary fan. For the embodiment of FIG. 2, the fan 252 is an open rotor fan, also referred to as an unducted fan. However, in other embodiments, the fan 252 may be ducted, e.g., by a fan casing or a nacelle circumferentially surrounding the fan 252, similar to the embodiment of FIG. 1. The fan 252 includes a plurality of fan blades 254 (only one shown in FIG. 2) that extends in the radial direction R from a fan root 251 to a fan tip 253. The plurality of fan blades 254 is rotatable about the longitudinal centerline axis 212 via a fan shaft 256. As shown in FIG. 2, the fan shaft 256 is coupled with the LP shaft 238 via a speed reduction gearbox or a power gearbox, also referred to as a gearbox assembly 255, e.g., in an indirect-drive configuration.

The gearbox assembly 255 is shown schematically in FIG. 2. The gearbox assembly 255 includes a plurality of gears for adjusting the rotational speed of the fan shaft 256 and, thus, the fan 252 relative to the LP shaft 238 to a more efficient rotational fan speed. The gearbox assembly 255 has a gear ratio in a range of 6:1 to 14:1, of 6:1 to 12:1, of 7:1 to 11:1, or of 8:1 to 10:1, and may be configured in a star-star configuration or a star-planetary configuration, as detailed further below. Preferably, the gearbox assembly 255 has a gear ratio of 8.57:1 for an unducted fan engine (e.g., the turbofan engine 210). The gearbox assembly 255 is a compound gearbox (e.g., having a plurality of stages of gear assemblies).

The fan blades 254 can be arranged in equal spacing around the longitudinal centerline axis 212. Each fan blade 254 extends outwardly from a disk (not shown in FIG. 2) generally along the radial direction R. The disk is covered by a fan hub 257 that is rotatable and aerodynamically contoured to promote an airflow through the plurality of fan blades 254. Each fan blade 254 has a root and a tip, and a span defined therebetween. Each of the plurality of fan blades 254 defines a pitch axis P. For the embodiment of FIG. 2, each of the plurality of fan blades 254 of the fan 252 is rotatable about their respective pitch axis P, e.g., in unison with one another. A fan pitch actuation system (FPAS) 258 controls one or more actuators 259 to pitch the fan blades 254 about their respective pitch axis P. The FPAS 258 is disposed within the fan hub 257. The FPAS 258 changes the pitch of the fan blades 254 between a fine pitch angle (minimum pitch angle with respect to the incoming air flow) and a coarse pitch angle (maximum pitch angle with respect to the incoming air flow). Coarse pitch angles increase the aerodynamic drag on the fan blades 254 and result in a lower fan rotational speed, and fine pitch angles result in a higher fan rotational speed. The FPAS 258 can pitch the fan blades 254 to any pitch angle between the coarse pitch angle and the fine pitch angle. A maximum coarse pitch angle corresponds to a feather position of the fan blades 254 such that the fan rotational speed is zero or about zero.

The fan assembly 250 further includes a fan guide vane array 260 that includes a plurality of fan guide vanes 262 (only one shown in FIG. 2) disposed around the longitudinal centerline axis 212. For the embodiment of FIG. 2, the plurality of fan guide vanes 262 is not rotatable about the longitudinal centerline axis 212. Each of the plurality of fan guide vanes 262 has a root and a tip, and a span defined therebetween. The plurality of fan guide vanes 262 can be unshrouded as shown in FIG. 2 or can be shrouded, e.g., by an annular shroud spaced outward from the tips of the fan guide vanes 262 along the radial direction R. Each of the plurality of fan guide vanes 262 defines a vane pitch axis 264. For the embodiment of FIG. 2, each of the plurality of fan guide vanes 262 of the fan guide vane array 260 is rotatable about their respective vane pitch axis 264, e.g., in unison with one another. One or more actuators 266 are controlled to pitch the plurality of fan guide vanes 262 about their respective vane pitch axis 264. In other embodiments, each of the plurality of fan guide vanes 262 is fixed or is unable to be pitched about the vane pitch axis 264. The plurality of fan guide vanes 262 is mounted to a fan cowl 270. The fan cowl 270 includes a fan frame 271 that supports the fan assembly 250.

The fan cowl 270 annularly encases at least a portion of the core cowl 222 and is generally positioned outward of the core cowl 222 along the radial direction R. Particularly, a downstream section of the fan cowl 270 extends over a forward portion of the core cowl 222 to define a fan flowpath, also referred to as a fan duct 272. Incoming air enters through the fan duct 272 through a fan duct inlet 276 and exits through a fan exhaust nozzle 278 to produce propulsive thrust. The fan duct 272 is an annular duct positioned generally outward of the core duct 242 along the radial direction R. The fan cowl 270 and the core cowl 222 are connected together and supported by a plurality of struts 274 (only one shown in FIG. 2) that extends substantially radially and are circumferentially spaced about the longitudinal centerline axis 212. The plurality of struts 274 is each aerodynamically contoured to direct air flowing thereby. Other struts, in addition to the plurality of struts 274, can be used to connect and to support the fan cowl 270 and the core cowl 222.

The turbofan engine 210 also defines or includes an inlet duct 280. The inlet duct 280 extends between an engine inlet 282 and the core inlet 224 and the fan duct inlet 276. The engine inlet 282 is defined generally at the forward end of the fan cowl 270 and is positioned between the fan 252 and the fan guide vane array 260 along the axial direction A. The inlet duct 280 is an annular duct that is positioned inward of the fan cowl 270 along the radial direction R. Air flowing downstream along the inlet duct 280 is split, not necessarily evenly, into the core duct 242 and the fan duct 272 by a splitter 284 of the core cowl 222. The inlet duct 280 is wider than the core duct 242 along the radial direction R. The inlet duct 280 is also wider than the fan duct 272 along the radial direction R.

The fan assembly 250 also includes a mid-fan 286. The mid-fan 286 includes a plurality of mid-fan blades 288 (only one shown in FIG. 2). The plurality of mid-fan blades 288 is rotatable, e.g., about the longitudinal centerline axis 212. The mid-fan 286 is drivingly coupled with the LP turbine 234 via the LP shaft 238. The plurality of mid-fan blades 288 can be arranged in equal circumferential spacing about the longitudinal centerline axis 212. The plurality of mid-fan blades 288 is annularly surrounded (e.g., ducted) by the fan cowl 270. In this regard, the mid-fan 286 is positioned inward of the fan cowl 270 along the radial direction R. The mid-fan 286 is positioned within the inlet duct 280 upstream of both the core duct 242 and the fan duct 272. A ratio of a span of a fan blade 254 to that of a mid-fan blade 288 (a span is measured from a root to tip of the respective blade) is greater than two and less than ten, to achieve the desired benefits of the third stream (S3), particularly, the additional thrust it offers to the engine, which can enable a smaller diameter fan blade 254 (benefits engine installation).

Accordingly, air flowing through the inlet duct 280 flows across the plurality of mid-fan blades 288 and is accelerated downstream thereof. At least a portion of the air accelerated by the mid-fan blades 288 flows into the fan duct 272 and is ultimately exhausted through the fan exhaust nozzle 278 to produce propulsive thrust. Also, at least a portion of the air accelerated by the plurality of mid-fan blades 288 flows into the core duct 242 and is ultimately exhausted through the core exhaust nozzle 240 to produce propulsive thrust. Generally, the mid-fan 286 is a compression device positioned downstream of the engine inlet 282. The mid-fan 286 is operable to accelerate air into the fan duct 272, also referred to as a secondary bypass passage.

During operation of the turbofan engine 210, an initial airflow or an incoming airflow passes through the fan blades 254 of the fan 252 and splits into a first airflow and a second airflow. The first airflow bypasses the engine inlet 282 and flows generally along the axial direction A outward of the fan cowl 270 along the radial direction R. The first airflow accelerated by the fan blades 254 passes through the fan guide vanes 262 and continues downstream thereafter to produce a primary propulsion stream or a first thrust stream S1. A majority of the net thrust produced by the turbofan engine 210 is produced by the first thrust stream S1. The second airflow enters the inlet duct 280 through the engine inlet 282.

The second airflow flowing downstream through the inlet duct 280 flows through the plurality of mid-fan blades 288 of the mid-fan 286 and is consequently compressed. The second airflow flowing downstream of the mid-fan blades 288 is split by the splitter 284 located at the forward end of the core cowl 222. Particularly, a portion of the second airflow flowing downstream of the mid-fan 286 flows into the core duct 242 through the core inlet 224. The portion of the second airflow that flows into the core duct 242 is progressively compressed by the LP compressor 226 and the HP compressor 228, and is ultimately discharged into the combustion section. The discharged pressurized air stream flows downstream to the combustor 230 where fuel is introduced to generate combustion gases or products.

The combustor 230 defines an annular combustion chamber that is generally coaxial with the longitudinal centerline axis 212. The combustor 230 receives pressurized air from the HP compressor 228 via a pressure compressor discharge outlet. A portion of the pressurized air flows into a mixer. Fuel is injected by a fuel nozzle (omitted for clarity) to mix with the pressurized air thereby forming a fuel-air mixture that is provided to the combustion chamber for combustion. Ignition of the fuel-air mixture is accomplished by one or more igniters (omitted for clarity), and the resulting combustion gases flow along the axial direction A toward, and into, a first stage turbine nozzle 233 of the HP turbine 232. The first stage turbine nozzle 233 is defined by an annular flow channel that includes a plurality of radially extending, circumferentially spaced nozzle vanes 235 that turn the combustion gases so that the combustion gases flow angularly and impinge upon first stage turbine blades of the HP turbine 232. The combustion gases exit the HP turbine 232 and flow through the LP turbine 234, and exit the core duct 242 through the core exhaust nozzle 240 to produce a core air stream, also referred to as a second thrust stream S2. As noted above, the HP turbine 232 drives the HP compressor 228 via the HP shaft 236, and the LP turbine 234 drives the LP compressor 226, the fan 252, and the mid-fan 286 via the LP shaft 238.

The other portion of the second airflow flowing downstream of the mid-fan 286 is split by the splitter 284 into the fan duct 272. The air enters the fan duct 272 through the fan duct inlet 276. The air flows generally along the axial direction A through the fan duct 272 and is ultimately exhausted from the fan duct 272 through the fan exhaust nozzle 278 to produce a third stream, also referred to as a third thrust stream S3.

The third thrust stream S3 is a secondary air stream that increases fluid energy to produce a minority of total engine system thrust. In some embodiments, a pressure ratio of the third stream is higher than that of the primary propulsion stream (e.g., a bypass or a propeller driven propulsion stream). The thrust may be produced through a dedicated nozzle or through mixing of the secondary air stream with the primary propulsion stream or a core air stream, e.g., into a common nozzle. In certain embodiments, an operating temperature of the secondary air stream is less than a maximum compressor discharge temperature for the engine. Furthermore, in certain embodiments, aspects of the third stream (e.g., airstream properties, mixing properties, or exhaust properties), and thereby a percent contribution to total thrust, are passively adjusted during engine operation or can be modified purposefully through the use of engine control features (such as fuel flow, electric machine power, variable stators, variable inlet guide vanes, valves, variable exhaust geometry, or fluidic features) to adjust or to improve overall system performance across a broad range of potential operating conditions.

The turbofan engine 210 depicted in FIG. 2 is by way of example only. In other embodiments, the turbofan engine 210 may have other suitable configurations. For example, the fan 252 can be ducted by a fan casing or a nacelle such that a bypass passage is defined between the fan casing and the fan cowl 270. Moreover, in other embodiments, any other suitable number or configuration of compressors, turbines, shafts, or a combination thereof may be provided. In still other embodiments, aspects of the present disclosure may be incorporated into any other suitable turbofan engine, such as, for example, turbofan engines defining two streams (e.g., a bypass stream and a core air stream).

Further, for the depicted embodiment of FIG. 2, the turbofan engine 210 includes an electric machine 290 (e.g., a motor-generator) operably coupled with a rotating component thereof. In this regard, the turbofan engine 210 is a hybrid-electric propulsion machine. Particularly, as shown in FIG. 2, the electric machine 290 is operatively coupled with the LP shaft 238. The electric machine 290 can be mechanically connected to the LP shaft 238, either directly, or indirectly, e.g., by way of a gearbox assembly 292 (shown schematically in FIG. 2). Further, although, in this embodiment the electric machine 290 is operatively coupled with the LP shaft 238 at an aft end of the LP shaft 238, the electric machine 290 can be coupled with the LP shaft 238 at any suitable location or can be coupled to other rotating components of the turbofan engine 210, such as the HP shaft 236 or the LP shaft 238. For instance, in some embodiments, the electric machine 290 can be coupled with the LP shaft 238 and positioned forward of the mid-fan 286 along the axial direction A. In some embodiments, the turbofan engine of FIG. 1 also includes an electric machine coupled to the LP shaft and located in the tail cone of the engine.

In some embodiments, the electric machine 290 can be an electric motor operable to drive or to motor the LP shaft 238. In other embodiments, the electric machine 290 can be an electric generator operable to convert mechanical energy into electrical energy. In this way, electrical power generated by the electric machine 290 can be directed to various engine systems or aircraft systems. In some embodiments, the electric machine 290 can be a motor/generator with dual functionality. The electric machine 290 includes a rotor 294 and a stator 296. The rotor 294 is coupled to the LP shaft 238 and rotates with rotation of the LP shaft 238. In this way, the rotor 294 rotates with respect to the stator 296, thereby generating electrical power. Although the electric machine 290 has been described and illustrated in FIG. 2 as having a particular configuration, the present disclosure may apply to electric machines having alternative configurations. For instance, the rotor 294 or the stator 296 may have different configurations or may be arranged in a different manner than illustrated in FIG. 2.

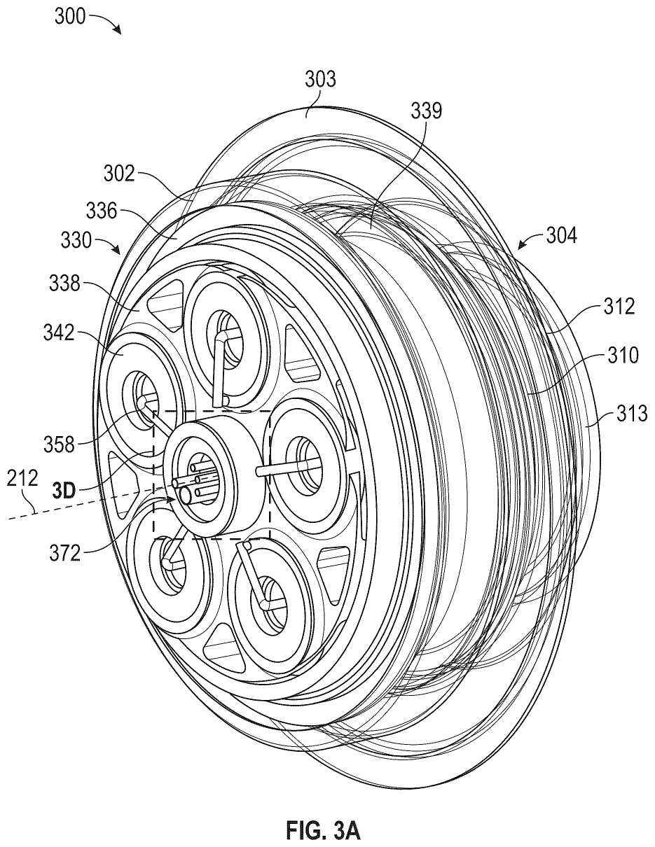

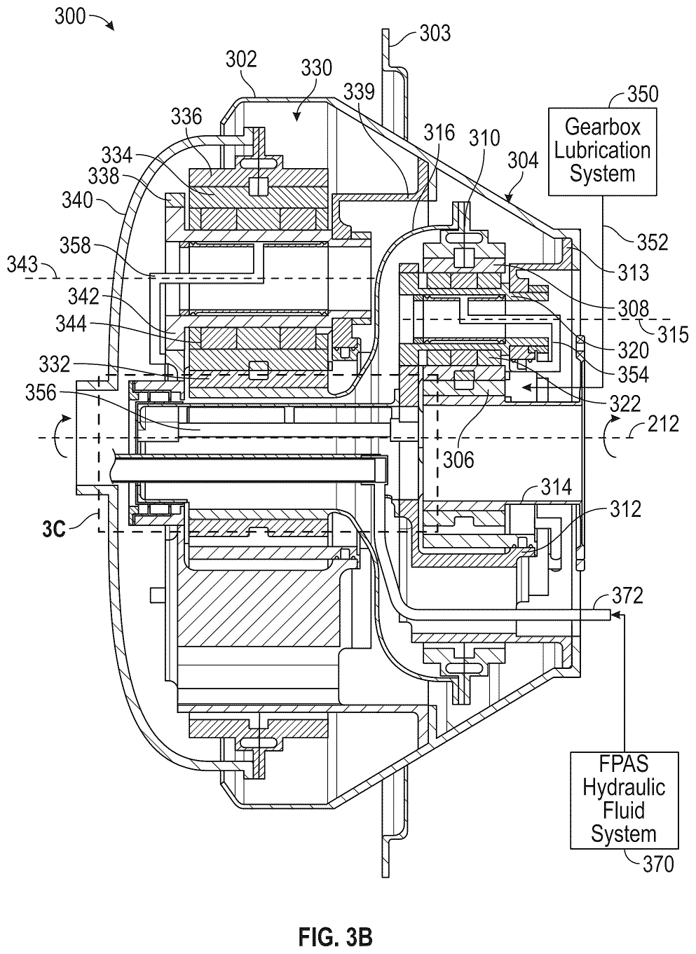

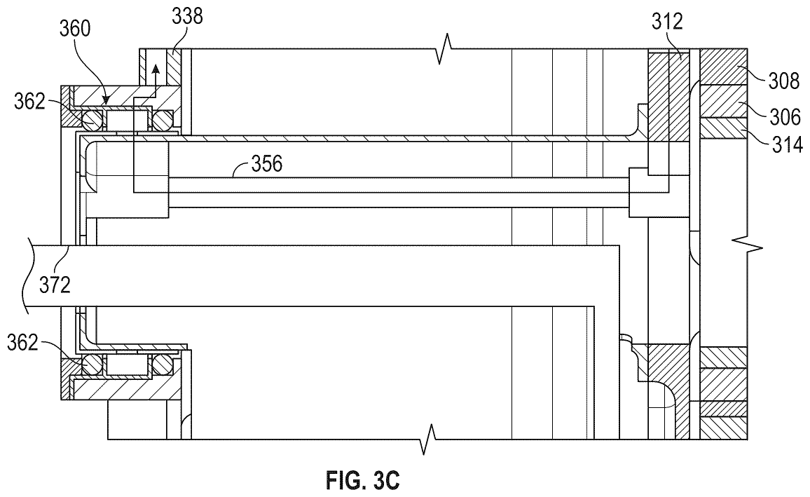

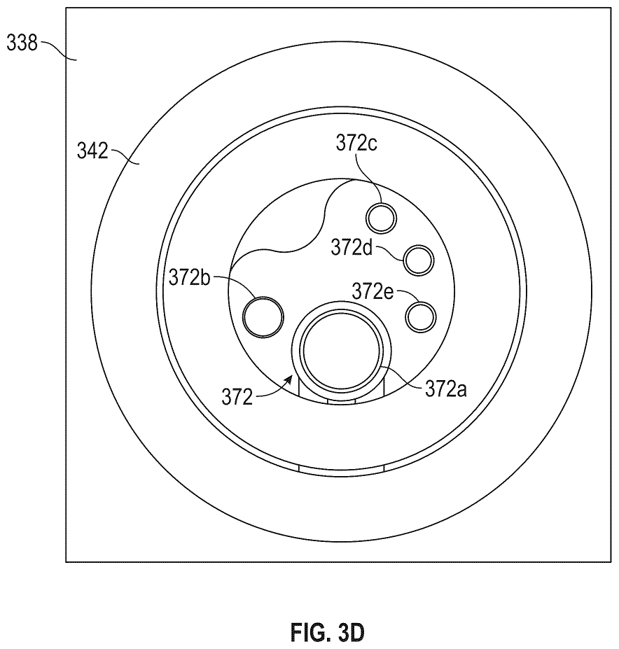

FIG. 3A is an elevational view showing a counterclockwise gearbox assembly 300 for a turbofan engine, according to the present disclosure. FIG. 3B is a schematic cross-sectional view of the counterclockwise gearbox assembly 300, taken along the longitudinal centerline axis 212 of the counterclockwise gearbox assembly 300, according to the present disclosure. FIG. 3C is an enlarged schematic cross-sectional view of the counterclockwise gearbox assembly 300, taken at detail 3C in FIG. 3B, according to the present disclosure. FIG. 3D is an enlarged schematic front view of the counterclockwise gearbox assembly 300, taken at detail 3D in FIG. 3A, according to the present disclosure.

The counterclockwise gearbox assembly 300 can be utilized as the gearbox assembly 255 of the turbofan engine 210 of FIG. 2. In particular, the counterclockwise gearbox assembly 300 is utilized in the first turbofan engine 110a of FIG. 1 for rotating the first fan 152a in the first direction 111 (counterclockwise direction).

The counterclockwise gearbox assembly 300 has a counterclockwise rotational output (e.g., the output of the counterclockwise gearbox assembly 300 rotates in the counterclockwise direction). The counterclockwise gearbox assembly 300 includes a counterclockwise gearbox casing 302 (shown transparent in FIG. 3A for clarity) having a counterclockwise gearbox coupling 303 that couples the counterclockwise gearbox assembly 300 to a static structure of the turbofan engine (e.g., the fan frame 271 of FIG. 2). The counterclockwise gearbox coupling 303 is a flex mount that is a mounting structure that couples the gearbox assembly to the static structure of the turbofan engine. A flex mount allows displacement of the gearbox assembly with respect to the static structure in the axial direction A, the radial direction R, and/or the circumferential direction C.

The counterclockwise gearbox assembly 300 is a double gearbox (DGB) assembly that includes a first stage gear assembly 304 and a second stage gear assembly 330. The first stage gear assembly 304 and the second stage gear assembly 330 are contained within the counterclockwise gearbox casing 302. The first stage gear assembly 304 and the second stage gear assembly 330 are in a serial relationship such that the first stage gear assembly 304 transfers power and torque to the second stage gear assembly 330. In this way, the first stage gear assembly 304 causes the second stage gear assembly 330 to rotate as the first stage gear assembly 304 rotates. As detailed further below, the first stage gear assembly 304 is an epicyclic gear assembly in a star configuration and the second stage gear assembly 330 is an epicyclic gear assembly in a star configuration. In this way, the input and the output of the first stage gear assembly 304 and the second stage gear assembly 330 both rotate in the counterclockwise direction. The counterclockwise gearbox assembly 300 has a gear ratio in a range of 6:1 to 12:1, of 7:1 to 11:1, or of 8:1 to 10:1. Preferably, the counterclockwise gearbox assembly 300 has a gear ratio of 8.57:1. The first stage gear assembly 304 has a gear ratio in a range of 2:1 to 3.5:1. The second stage gear assembly 330 has a gear ratio in a range of 2:1 to 3.5:1.

With reference to FIG. 3B, the first stage gear assembly 304 is an epicyclic gear assembly and includes a first stage sun gear 306, a plurality of first stage planet gears 308 (only two of which are visible in FIG. 3B), and a first stage ring gear 310. For clarity, only a portion of the gears is shown. The first stage sun gear 306 has a first stage sun gear diameter. Each of the plurality of first stage planet gears 308 has a first stage planet gear diameter. The first stage ring gear 310 has a first stage ring gear diameter. The diameter of the gears is a pitch diameter of a pitch circle of the gears. The pitch circle is an imaginary circle that intersects the teeth of a gear at a point where the face of the teeth mesh with the face of the teeth of another gear. The first stage sun gear diameter is in a range of one hundred twelve millimeters (112 mm) to one hundred thirty-three millimeters (133 mm). The first stage planet gear diameter is in a range of one hundred fourteen millimeters (114 mm) to one hundred twenty-four millimeters (124 mm). The first stage ring gear diameter is in a range of three hundred forty-three millimeters (343 mm) to three hundred seventy-five millimeters (375 mm).

The plurality of first stage planet gears 308 is contained and supported by a first stage planet carrier 312 (shown schematically in FIG. 3B). The first stage gear assembly 304 is a star configuration, in which the first stage planet carrier 312 is held fixed, with the first stage ring gear 310 allowed to rotate. For example, the first stage planet carrier 312 is coupled to the counterclockwise gearbox casing 302 (which is coupled to the static structure of the turbofan engine) via a first stage planet carrier coupling 313.

The counterclockwise gearbox assembly 300 includes an input shaft 314, an interstage shaft 316, and an output shaft 340. In FIG. 3B, the first stage sun gear 306 is coupled to the input shaft 314. In some embodiments, the input shaft 314 and the first stage sun gear 306 are a single unitary component. The input shaft 314 is coupled to the turbine section (FIG. 2) of the first turbofan engine 110a (FIG. 1). For example, the input shaft 314 can be coupled to, or can embody, the LP shaft 238 (FIG. 2). Radially outward of the first stage sun gear 306, and intermeshing therewith, is the plurality of first stage planet gears 308 that is coupled together and supported by the first stage planet carrier 312. The first stage planet carrier 312 supports the plurality of first stage planet gears 308 such that the plurality of first stage planet gears 308 is held fixed with respect to the longitudinal centerline axis 212, while enabling each first stage planet gear 308 of the plurality of first stage planet gears 308 to rotate about a first stage planet gear longitudinal axis 315 of each first stage planet gear 308. Radially outwardly of the plurality of first stage planet gears 308, and intermeshing therewith, is the first stage ring gear 310, which is an annular ring gear. In the star configuration, the interstage shaft 316 is driven by the first stage ring gear 310. The interstage shaft 316 is an output of the first stage gear assembly 304 and an input of the second stage gear assembly 330. For example, the first stage ring gear 310 is coupled to the second stage gear assembly 330 via the interstage shaft 316 such that rotation of the interstage shaft 316 causes the second stage gear assembly 330 to rotate. In this way, the first stage ring gear 310 is an output of the first stage gear assembly 304.

Each of the first stage planet gears 308 includes a first stage planet pin 320, about which a respective first stage planet gear 308 rotates. For example, the first stage planet pin 320 is disposed within a respective first stage planet gear 308. Each of the first stage planet gears 308 is supported by one or more first stage roller bearings 322 disposed radially between the first stage planet pin 320 and the first stage planet gear 308. FIG. 3B shows the one or more first stage roller bearings 322 include two first stage roller bearings 322 that are spaced axially from each other. A respective first stage planet gear 308, however, can include any number of first stage roller bearings 322 for supporting rotation of the first stage planet gear 308 about the first stage planet pin 320. As detailed further below, a lubricant (e.g., oil) is supplied to the first stage gear assembly 304 to lubricate the gears and the first stage roller bearings 322.

The second stage gear assembly 330 is an epicyclic gear assembly and includes a second stage sun gear 332, a plurality of second stage planet gears 334 (only two of which are visible in FIG. 3B), and a second stage ring gear 336. For clarity, only a portion of the gears is shown. The second stage sun gear 332 has a second stage sun gear diameter. Each of the plurality of second stage planet gears 334 has a second stage planet gear diameter. The second stage ring gear 336 has a second stage ring gear diameter. The second stage sun gear diameter is greater than the first stage sun gear diameter. The second stage gear assembly 300 transfers a greater amount of torque than the first stage gear assembly 304. Accordingly, the second stage planet gear diameter is greater than first stage planet gear diameter. The second stage ring gear diameter is greater than the first stage ring gear diameter. The second stage sun gear diameter is in a range of one hundred fifty-one millimeters (151 mm) to one hundred seventy-nine millimeters (179 mm). The second stage planet gear diameter is in a range of one hundred sixty-three millimeters (163 mm) to one hundred seventy-nine millimeters (179 mm). The second stage ring gear diameter is in a range of four hundred eighty-one millimeters (481 mm) to five hundred twenty-eight millimeters (528 mm).

The plurality of second stage planet gears 334 is contained and supported by a second stage planet carrier 338 (shown schematically in FIG. 3B). The second stage gear assembly 330 is a star configuration, in which the second stage planet carrier 338 is held fixed, with the second stage ring gear 336 allowed to rotate. For example, the second stage planet carrier 338 is coupled to the counterclockwise gearbox casing 302 (which is coupled to the static structure of the turbofan engine) via a second stage planet carrier coupling 339.

In FIG. 3B, the second stage sun gear 332 is coupled to the interstage shaft 316 such that the interstage shaft 316 is an input of the second stage gear assembly 330. In some embodiments, the interstage shaft 316 and the second stage sun gear 332 are a single unitary component. Radially outward of the second stage sun gear 332, and intermeshing therewith, is the plurality of second stage planet gears 334 that is coupled together and supported by the second stage planet carrier 338. The second stage planet carrier 338 supports the plurality of second stage planet gears 334 such that the plurality of second stage planet gears 334 is held fixed with respect to the longitudinal centerline axis 212, while enabling each second stage planet gear 334 of the plurality of second stage planet gears 334 to rotate about a second stage planet gear longitudinal axis 343 of each second stage planet gear 334. Radially outwardly of the plurality of second stage planet gears 334, and intermeshing therewith, is the second stage ring gear 336, which is an annular ring gear. In the star configuration, the output shaft 340 is driven by the second stage ring gear 336. For example, the second stage ring gear 336 is coupled to the output shaft 340 such that rotation of the second stage ring gear 336 causes the output shaft 340 to rotate. In this way, the second stage ring gear 336 is an output of the second stage gear assembly 330.

Each of the second stage planet gears 334 includes a second stage planet pin 342, about which a respective second stage planet gear 334 rotates. For example, the second stage planet pin 342 is disposed within a respective second stage planet gear 334. Each of the second stage planet gears 334 is supported by one or more second stage roller bearings 344 disposed radially between the second stage planet pin 342 and the second stage planet gear 334. FIG. 3B shows the one or more second stage roller bearings 344 include two second stage roller bearings 344 that are spaced axially from each other. A respective second stage planet gear 334, however, can include any number of second stage roller bearings 344 for supporting rotation of the second stage planet gear 334 about the second stage planet pin 342. As detailed further below, the lubricant (e.g., oil) is supplied to the second stage gear assembly 330 to lubricate the gears and the second stage roller bearings 344.

The first turbofan engine 110a (FIG. 1) includes a gearbox lubrication system 350 for supplying the lubricant to the counterclockwise gearbox assembly 300 to lubricate the gears and the roller bearings. The gearbox lubrication system 350 includes one or more gearbox lubricant supply lines 352 for supplying the lubricant to the first stage gear assembly 304 and the second stage gear assembly 330. The gearbox lubrication system 350 can include one or more lubricant tanks for storing lubricant therein and one or more lubricant pumps for pumping the lubricant from the lubricant tanks to the counterclockwise gearbox assembly 300 through the one or more gearbox lubricant supply lines 352. The first stage gear assembly 304 includes one or more first stage lubricant supply lines 354 in fluid communication with the gearbox lubricant supply lines 352. The one or more first stage lubricant supply lines 354 extend through the plurality of first stage planet gears 308 and are in fluid communication with the first stage planet gears 308 and the one or more first stage roller bearings 322. In particular, a respective one of the first stage lubricant supply lines 354 extends through a respective first stage planet pin 320 to supply the lubricant to the one or more first stage roller bearings 322.

The gearbox lubrication system 350 also includes an interstage lubricant supply line 356 that extends from the first stage planet carrier 312 to the second stage planet carrier 338 through the interstage shaft 316. The interstage lubricant supply line 356 is in fluid communication with the gearbox lubricant supply lines 352 such that the gearbox lubrication system 350 supplies the lubricant to the second stage gear assembly 330 through the interstage lubricant supply line 356. The second stage gear assembly 330 includes one or more second stage lubricant supply lines 358 in fluid communication with the interstage lubricant supply line 356. The one or more second stage lubricant supply lines 358 extend through the plurality of second stage planet gears 334 and are in fluid communication with the second stage planet gears 334 and the one or more second stage roller bearings 344. In particular, a respective one of the second stage lubricant supply lines 358 extends through a respective second stage planet pin 342 to supply the lubricant to the one or more second stage roller bearings 344.

With reference to FIG. 3C, the gearbox lubrication system 350 includes a lubricant distributor 360 that is integrated with the second stage planet carrier 338. The lubricant distributor 360 is a flowpath within the second stage planet carrier 338 that is in fluid communication with the interstage lubricant supply line 356 and the one or more second stage lubricant supply lines 358. In this way, the lubricant distributor 360 directs the lubricant from the interstage lubricant supply line 356 to each of the one or more second stage lubricant supply lines 358. The lubricant distributor 360 is an annular about the longitudinal centerline axis 212 and each of the one or more second stage lubricant supply lines 358 is in fluid communication with the lubricant distributor 360. The lubricant distributor 360 includes one or more seals 362 for sealing the lubricant distributor 360 and preventing the lubricant from leaking out of the lubricant distributor 360. The one or more seals 362 can include O-rings, or the like.

With reference back to FIG. 3B, the first turbofan engine 110a (FIG. 1) includes a fan pitch actuation system (FPAS) hydraulic fluid system 370 for supplying hydraulic fluid (e.g., oil) to the FPAS 258 (FIG. 2) for actuating the one or more actuators 259 (FIG. 2) to pitch the fan blades 254 (FIG. 2) about their respective pitch axis P. The FPAS hydraulic fluid system 370 includes one or more FPAS hydraulic fluid supply lines 372 for supplying the hydraulic fluid to the FPAS 258. The FPAS hydraulic fluid system 370 can include one or more hydraulic fluid tanks for storing hydraulic fluid therein and one or more hydraulic fluid pumps for pressurizing and pumping the hydraulic fluid from the hydraulic fluid tanks to the FPAS 258 through the one or more FPAS hydraulic fluid supply lines 372. The one or more FPAS hydraulic fluid supply lines 372 extend through first stage gear assembly 304 and the second stage gear assembly 330 and are in fluid communication with the one or more actuators 259 (FIG. 2) of the FPAS 258 (FIG. 2) for supplying the hydraulic fluid to the one or more actuators 259 to actuate the actuators 259 and to change the pitch of the fan blades 254 (FIG. 2). In particular, the one or more FPAS hydraulic fluid supply lines 372 extend through the first stage planet carrier 312, through the interstage shaft 316, through the second stage sun gear 332, and through the second stage planet carrier 338. In this way, the one or more FPAS hydraulic fluid supply lines 372 extend through the counterclockwise gearbox assembly 300 (e.g., through the counterclockwise gearbox casing 302) from an input side of the counterclockwise gearbox assembly 300 to an output side of the counterclockwise gearbox assembly 300 and extend to the one or more actuators 259. The input side is an axial side of the counterclockwise gearbox assembly 300 through which the input shaft 314 extends, and the output side is an axial side of the counterclockwise gearbox assembly 300 through which the output shaft 340 extends.

With reference to FIG. 3D, the one or more FPAS hydraulic fluid supply lines 372 include a first FPAS hydraulic fluid supply line 372a, a second FPAS hydraulic fluid supply line 372b, a third FPAS hydraulic fluid supply line 372c, a fourth FPAS hydraulic fluid supply line 372d, and a fifth FPAS hydraulic fluid supply line 372e. While FIG. 3D shows five FPAS hydraulic fluid supply lines 372, the one or more FPAS hydraulic fluid supply lines 372 can include any number of FPAS hydraulic fluid supply lines. The first FPAS hydraulic fluid supply line 372a is a coarse hydraulic fluid supply line for supplying the hydraulic fluid to the one or more actuators 25 (FIG. 2) 9 to rotate the fan blades 254 (FIG. 2) about the pitch axis P (FIG. 2) towards the coarse pitch angle. The second FPAS hydraulic fluid supply line 372b is a fine hydraulic fluid supply line for supplying the hydraulic fluid to the one or more actuators 259 to rotate the fan blades 254 about the pitch axis P towards the fine pitch angle. The third FPAS hydraulic fluid supply line 372c is a feather lock (FLO) hydraulic fluid supply line for locking the fan blades 254 (FIG. 2) in a feather position. The fourth FPAS hydraulic fluid supply line 372d is a thrust reverse lock (TRLO) hydraulic fluid supply line for locking the fan blades 254 (FIG. 2) in a thrust reverse position to generate reverse thrust through the turbine engine 210 (FIG. 210). The fifth FPAS hydraulic fluid supply line 372e is an auxiliary hydraulic fluid supply line for pressurizing a secondary coarse chamber of the FPAS 258 (FIG. 2) for changing the pitch of the fan blades 254 (FIG. 2) towards the coarse pitch angle.

In operation, the input shaft 314 (e.g., the LP shaft 238) rotates and transfers torque to the output shaft 340 through the first stage gear assembly 304 and the second stage gear assembly 330. In particular, the input shaft 314 transfers the torque to the first stage sun gear 306, causing the first stage sun gear 306 to rotate. The input shaft 314 and the first stage sun gear 306 rotate in the counterclockwise direction. The first stage sun gear 306 transfers the torque to the plurality of first stage planet gears 308 and drives the plurality of first stage planet gears 308 such that each first stage planet gear 308 rotates about the first stage planet gear longitudinal axis 315. The plurality of first stage planet gears 308 rotates in the clockwise direction (e.g., in a direction opposite of the first stage sun gear 306). The first stage planet carrier 312 holds the plurality of first stage planet gears 308 stationary with respect to the longitudinal centerline axis 212. The plurality of first stage planet gears 308 transfers the torque to the first stage ring gear 310 and drives the first stage ring gear 310 such that the first stage ring gear 310 rotates, thereby causing the interstage shaft 316 to rotate. The first stage ring gear 310 (and the interstage shaft 316) rotates in the counterclockwise direction such that the first stage ring gear 310 rotates in the same direction as the first stage sun gear 306.

The first stage ring gear 310 transfers the torque to the second stage sun gear 332 through the interstage shaft 316, causing the second stage sun gear 332 to rotate. The second stage sun gear 332 rotates in the counterclockwise direction. The second stage sun gear 332 transfers the torque to the plurality of second stage planet gears 334 and drives the plurality of second stage planet gears 334 such that each second stage planet gear 334 rotates about the second stage planet gear longitudinal axis 343. The plurality of second stage planet gears 334 rotates in the clockwise direction (e.g., in a direction opposite of the second stage sun gear 332). The second stage planet carrier 338 holds the plurality of second stage planet gears 334 stationary with respect to the longitudinal centerline axis 212. The plurality of second stage planet gears 334 transfers the torque to the second stage ring gear 336 and drives the second stage ring gear 336 such that the second stage ring gear 336 rotates, thereby causing the output shaft 340 to rotate. The second stage ring gear 336 (and the output shaft 340) rotates in the counterclockwise direction such that the second stage ring gear 336 rotates in the same direction as the second stage sun gear 332. Thus, the first fan 152a (coupled to the output shaft 340) rotates in the counterclockwise direction.

As the counterclockwise gearbox assembly 300 operates, the gearbox lubrication system 350 supplies the lubricant to the first stage gear assembly 304 through the one or more gearbox lubricant supply lines 352. In particular, the one or more gearbox lubricant supply lines 352 direct the lubricant to the one or more first stage lubricant supply lines 354. The one or more first stage lubricant supply lines 354 direct the lubricant to at least one of the one or more first stage roller bearings 322 or the first stage gears (the first stage sun gear 306, the plurality of first stage planet gears 308, and the first stage ring gear 310) to lubricate the one or more first stage roller bearings 322 or the first stage gears. The one or more gearbox lubricant supply lines 352 also direct the lubricant to the interstage lubricant supply line 356. The interstage lubricant supply line 356 directs the lubricant to the one or more second stage lubricant supply lines 358 through the lubricant distributor 360 (FIG. 3C). The one or more second stage lubricant supply lines 358 direct the lubricant to at least one of the one or more second stage roller bearings 344 or the second stage gears (the second stage sun gear 332, the plurality of second stage planet gears 334, and the second stage ring gear 336) to lubricate the one or more second stage roller bearings 344 or the first stage gears.

As the first turbofan engine 110a operates, the FPAS hydraulic fluid system 370 supplies the hydraulic fluid to the FPAS 258 (FIG. 2) to actuate the fan blades 254 (FIG. 2). In particular, the one or more FPAS hydraulic fluid supply lines 372 direct the hydraulic fluid to the one or more actuators 259 (FIG. 2) to rotate the fan blades 254 to change the pitch angle of the fan blades 254. For example, the first FPAS hydraulic fluid supply line 372a directs the hydraulic fluid to the one or more actuators 259 to rotate the fan blades 254 about the pitch axis P towards the coarse pitch angle. The second FPAS hydraulic fluid supply line 372b directs the hydraulic fluid to the one or more actuators 259 to rotate the fan blades 254 about the pitch axis P towards the fine pitch angle. The third FPAS hydraulic fluid supply line 372c directs the hydraulic fluid to the actuators 259. The fourth FPAS hydraulic fluid supply line 372d directs the hydraulic fluid to the actuators 259. The fifth FPAS hydraulic fluid supply line 372e directs the hydraulic fluid to the actuators 259.

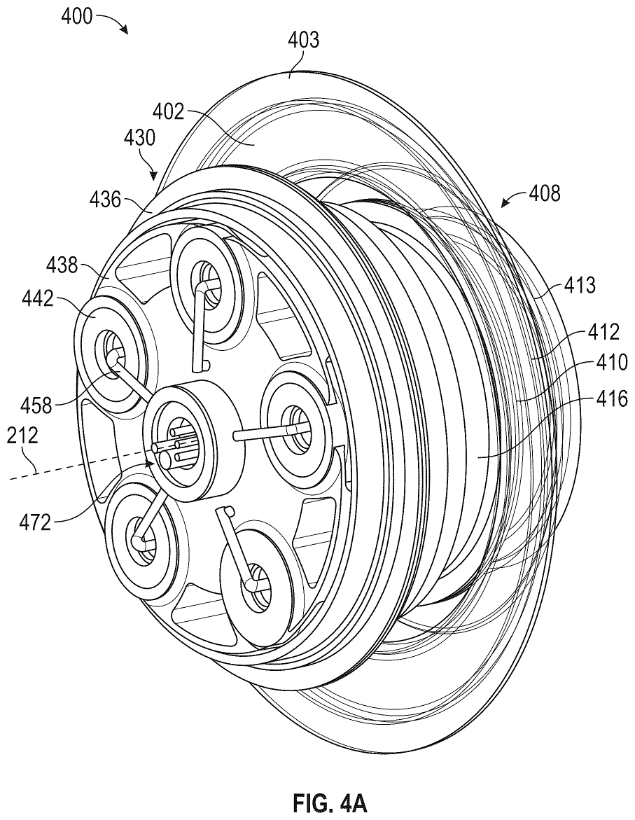

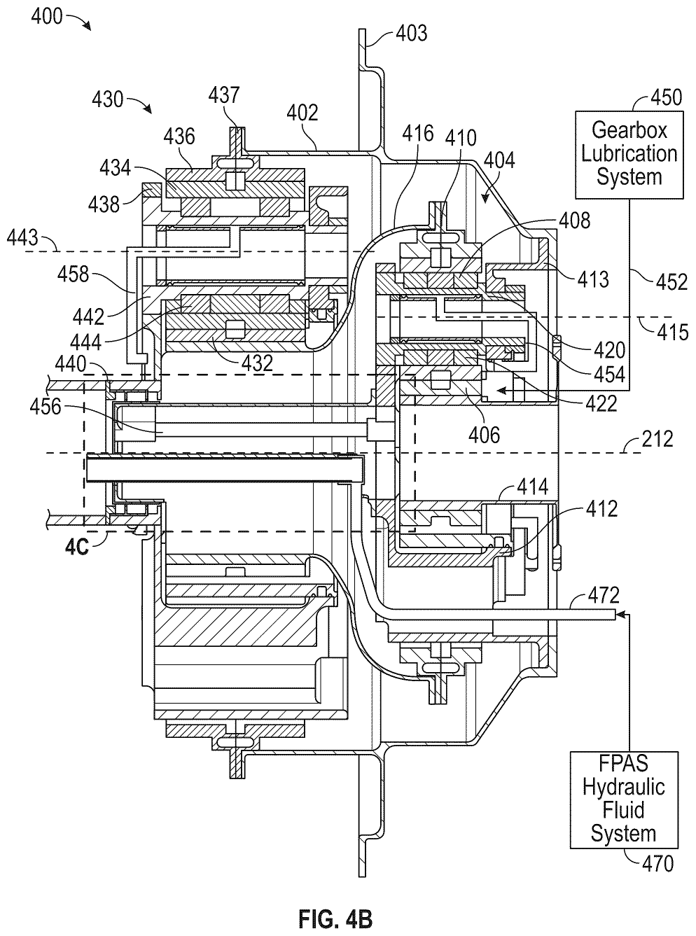

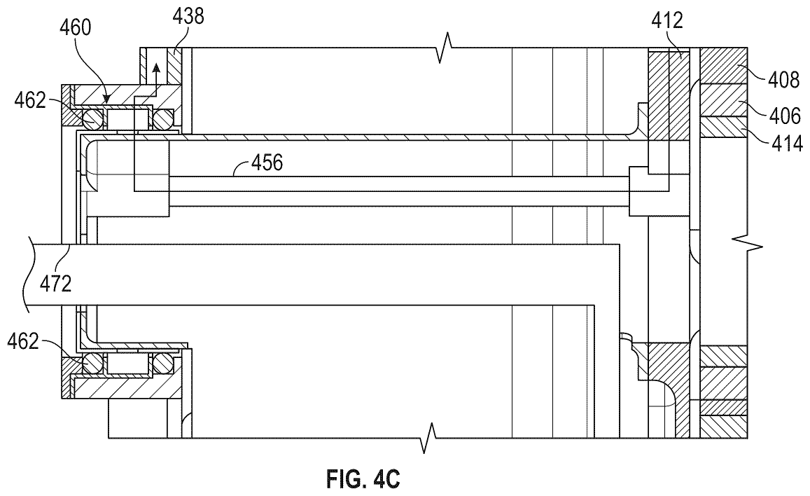

FIG. 4A is an elevational view showing a clockwise gearbox assembly 400 for a turbofan engine, according to the present disclosure. FIG. 4B is a schematic cross-sectional view of the clockwise gearbox assembly 400, taken along the longitudinal centerline axis 212 of the clockwise gearbox assembly 400, according to the present disclosure. FIG. 4C is an enlarged schematic cross-sectional view of the clockwise gearbox assembly 400, taken at detail 4C in FIG. 4B, according to the present disclosure.

The clockwise gearbox assembly 400 can be utilized as the gearbox assembly 255 of the turbofan engine 210 of FIG. 2. In particular, the clockwise gearbox assembly 400 is utilized in the second turbofan engine 110b of FIG. 1 for rotating the second fan 152b (FIG. 1) in the second direction 113 (FIG. 1) (clockwise direction).

The clockwise gearbox assembly 400 has a clockwise rotational output (e.g., the output of the clockwise gearbox assembly 400 rotates in the clockwise direction). The clockwise gearbox assembly 400 includes a clockwise gearbox casing 402 (shown transparent in FIG. 4A for clarity) having a clockwise gearbox coupling 403 that couples the clockwise gearbox assembly 400 to a static structure of the turbofan engine (e.g., the fan frame 271). The clockwise gearbox coupling 403 is a flex mount that is a mounting structure that couples the gearbox assembly to the static structure of the turbofan engine.

The clockwise gearbox assembly 400 is a double gearbox (DGB) assembly that includes a first stage gear assembly 404 and a second stage gear assembly 430. The first stage gear assembly 404 and the second stage gear assembly 430 are contained within the clockwise gearbox casing 402. The first stage gear assembly 404 and the second stage gear assembly 430 are in a serial relationship such that the first stage gear assembly 404 transfers power and torque to the second stage gear assembly 430. In this way, the first stage gear assembly 404 causes the second stage gear assembly 430 to rotate as the first stage gear assembly 404 rotates. As detailed further below, the first stage gear assembly 404 is an epicyclic gear assembly in a star configuration and the second stage gear assembly 430 is an epicyclic gear assembly in a planetary configuration. In this way, the input and the output of the first stage gear assembly 404 rotates in the counterclockwise direction. The input of the second stage gear assembly 430 rotates in the counterclockwise direction and the output of the second stage gear assembly 430 rotates in the clockwise direction. The clockwise gearbox assembly 400 has a gear ratio in a range of 6:1 to 12:1, of 7:1 to 11:1, or of 8:1 to 10:1. Preferably, the clockwise gearbox assembly 400 has a gear ratio of 8.57:1. The first stage gear assembly 404 has a gear ratio in a range of 2:1 to 3.5:1. The second stage gear assembly 330 has a gear ratio in a range of 2:1 to 3.5:1.

With reference to FIG. 4B, the first stage gear assembly 404 is an epicyclic gear assembly and includes a first stage sun gear 406, a plurality of first stage planet gears 408 (only two of which are visible in FIG. 4B), and a first stage ring gear 410. For clarity, only a portion of the gears is shown. The first stage sun gear 406 has a first stage sun gear diameter. Each of the plurality of first stage planet gears 408 has a first stage planet gear diameter. The first stage ring gear 410 has a first stage ring gear diameter. The diameter of the gears is a pitch diameter of a pitch circle of the gears. The pitch circle is an imaginary circle that intersects the teeth of a gear at a point where the face of the teeth mesh with the face of the teeth of another gear. The plurality of first stage planet gears 408 is contained and supported by a first stage planet carrier 412 (shown schematically in FIG. 4B). The first stage gear assembly 404 is a star configuration, in which the first stage planet carrier 412 is held fixed, with the first stage ring gear 410 allowed to rotate. For example, the first stage planet carrier 412 is coupled to the clockwise gearbox casing 402 (which is coupled to the static structure of the turbofan engine) via a first stage planet carrier coupling 413.

The clockwise gearbox assembly 400 includes an input shaft 414, an interstage shaft 416, and an output shaft 440. In FIG. 4B, the first stage sun gear 406 is coupled to the input shaft 414. In some embodiments, the input shaft 414 and the first stage sun gear 406 are a single unitary component. The input shaft 414 is coupled to the turbine section (FIG. 2) of the second turbofan engine 110b (FIG. 1). For example, the input shaft 414 can be coupled to, or can embody, the LP shaft 238 (FIG. 2). Radially outward of the first stage sun gear 406, and intermeshing therewith, is the plurality of first stage planet gears 408 that is coupled together and supported by the first stage planet carrier 412. The first stage planet carrier 412 supports the plurality of first stage planet gears 408 such that the plurality of first stage planet gears 408 is held fixed with respect to the longitudinal centerline axis 212, while enabling each first stage planet gear 408 of the plurality of first stage planet gears 408 to rotate about a first stage planet gear longitudinal axis 415 of each first stage planet gear 408. Radially outwardly of the plurality of first stage planet gears 408, and intermeshing therewith, is the first stage ring gear 410, which is an annular ring gear. In the star configuration, the interstage shaft 416 is driven by the first stage ring gear 410. The interstage shaft 416 is an output of the first stage gear assembly 404 and an input of the second stage gear assembly 430. For example, the first stage ring gear 410 is coupled to the second stage gear assembly 430 via the interstage shaft 416 such that rotation of the interstage shaft 416 causes the second stage gear assembly 430 to rotate. In this way, the first stage ring gear 410 is an output of the first stage gear assembly 404.

Each of the first stage planet gears 408 includes a first stage planet pin 420, about which a respective first stage planet gear 408 rotates. For example, the first stage planet pin 420 is disposed within a respective first stage planet gear 408. Each of the first stage planet gears 408 is supported by one or more first stage roller bearings 422 disposed radially between the first stage planet pin 420 and the first stage planet gear 408. FIG. 4B shows the one or more first stage roller bearings 422 include two first stage roller bearings 422 that are spaced axially from each other. A respective first stage planet gear 408, however, can include any number of first stage roller bearings 422 for supporting rotation of the first stage planet gear 408 about the first stage planet pin 420. As detailed further below, a lubricant (e.g., oil) is supplied to the first stage gear assembly 404 to lubricate the gears and the first stage roller bearings 422.

The second stage gear assembly 430 is an epicyclic gear assembly and includes a second stage sun gear 432, a plurality of second stage planet gears 434 (only two of which are visible in FIG. 4B), and a second stage ring gear 436. For clarity, only a portion of the gears is shown. The second stage sun gear 432 has a second stage sun gear diameter. Each of the plurality of second stage planet gears 434 has a second stage planet gear diameter. The second stage ring gear 436 has a second stage ring gear diameter. The second stage sun gear diameter is greater than the first stage sun gear diameter. The second stage planet gear diameter is greater than first stage planet gear diameter. The second stage ring gear diameter is greater than the first stage ring gear diameter. The plurality of second stage planet gears 434 is contained and supported by a second stage planet carrier 438 (shown schematically in FIG. 4B). The second stage gear assembly 430 is a planetary configuration, in which the second stage ring gear 436 is held fixed, with the second stage planet carrier 438 allowed to rotate. For example, the second stage ring gear 436 is coupled to the clockwise gearbox casing 402 (which is coupled to the static structure of the turbofan engine) via a second stage ring gear coupling 437.

In FIG. 4B, the second stage sun gear 432 is coupled to the interstage shaft 416 such that the interstage shaft 416 is an input of the second stage gear assembly 430. In some embodiments, the interstage shaft 416 and the second stage sun gear 432 are a single unitary component. Radially outward of the second stage sun gear 432, and intermeshing therewith, is the plurality of second stage planet gears 434 that is coupled together and supported by the second stage planet carrier 438. The second stage planet carrier 438 supports the plurality of second stage planet gears 434 such that the plurality of second stage planet gears 434 rotate about the longitudinal centerline axis 212 (rotate around the second stage sun gear 432), while enabling each second stage planet gear 434 of the plurality of second stage planet gears 434 to rotate about a second stage planet gear longitudinal axis 443 of each second stage planet gear 434. In the planetary configuration, the output shaft 440 is driven by the second stage planet carrier 438. For example, the second stage planet carrier 438 is coupled to the output shaft 440 such that rotation of the second stage planet carrier 438 causes the output shaft 440 to rotate. In this way, the second stage planet carrier 438 (e.g., the plurality of second stage planet gears 434) is an output of the second stage gear assembly 430. Radially outwardly of the plurality of second stage planet gears 434, and intermeshing therewith, is the second stage ring gear 436, which is an annular ring gear.

Each of the second stage planet gears 434 includes a second stage planet pin 442, about which a respective second stage planet gear 434 rotates. For example, the second stage planet pin 442 is disposed within a respective second stage planet gear 434. Each of the second stage planet gears 434 is supported by one or more second stage roller bearings 444 disposed radially between the second stage planet pin 442 and the second stage planet gear 434. FIG. 4B shows the one or more second stage roller bearings 444 include two second stage roller bearings 444 that are spaced axially from each other. A respective second stage planet gear 434, however, can include any number of second stage roller bearings 444 for supporting rotation of the second stage planet gear 434 about the second stage planet pin 442. As detailed further below, the lubricant (e.g., oil) is supplied to the second stage gear assembly 430 to lubricate the gears and the second stage roller bearings 444.

The second turbofan engine 110b (FIG. 1) includes a gearbox lubrication system 450 for supplying the lubricant to the clockwise gearbox assembly 400 to lubricate the gears and the roller bearings. The gearbox lubrication system 450 includes one or more gearbox lubricant supply lines 452 for supplying the lubricant to the first stage gear assembly 404 and the second stage gear assembly 430. The gearbox lubrication system 450 can include one or more lubricant tanks for storing lubricant therein and one or more lubricant pumps for pumping the lubricant from the lubricant tanks to the clockwise gearbox assembly 400 through the one or more gearbox lubricant supply lines 452. The first stage gear assembly 404 includes one or more first stage lubricant supply lines 454 in fluid communication with the gearbox lubricant supply lines 452. The one or more first stage lubricant supply lines 454 extend through the plurality of first stage planet gears 408 and are in fluid communication with the first stage planet gears 408 and the one or more first stage roller bearings 422. In particular, a respective one of the first stage lubricant supply lines 454 extends through a respective first stage planet pin 420 to supply the lubricant to the one or more first stage roller bearings 422.

The gearbox lubrication system 450 also includes an interstage lubricant supply line 456 that extends from the first stage planet carrier 412 to the second stage planet carrier 438 through the interstage shaft 416. The interstage lubricant supply line 456 is in fluid communication with the gearbox lubricant supply lines 452 such that the gearbox lubrication system 450 supplies the lubricant to the second stage gear assembly 430 through the interstage lubricant supply line 456. The second stage gear assembly 430 includes one or more second stage lubricant supply lines 458 in fluid communication with the interstage lubricant supply line 456. The one or more second stage lubricant supply lines 458 extend through the plurality of second stage planet gears 434 and are in fluid communication with the second stage planet gears 434 and the one or more second stage roller bearings 444. In particular, a respective one of the second stage lubricant supply lines 458 extends through a respective second stage planet pin 442 to supply the lubricant to the one or more second stage roller bearings 444.

With reference to FIG. 4C, the gearbox lubrication system 450 includes a lubricant distributor 460 that is integrated with the second stage planet carrier 438. The lubricant distributor 460 is an oil transfer bearing that includes a FPAS line integrated with the second stage planet carrier 438 and is in fluid communication with the interstage lubricant supply line 456 and the one or more second stage lubricant supply lines 458. In this way, the lubricant distributor 460 directs the lubricant from the interstage lubricant supply line 456 to each of the one or more second stage lubricant supply lines 458 as the second stage planet carrier 438 (and the one or more second stage lubricant supply lines 458) rotates. The lubricant distributor 460 is an annular about the longitudinal centerline axis 212 and each of the one or more second stage lubricant supply lines 458 is in fluid communication with the lubricant distributor 460. The lubricant distributor 460 includes one or more seals 462 for sealing the lubricant distributor 460 and preventing the lubricant from leaking out of the lubricant distributor 460. The one or more seals 462 can include O-rings, or the like.

With reference back to FIG. 4B, the second turbofan engine 110b includes a fan pitch actuation system (FPAS) hydraulic fluid system 470 for supplying the hydraulic fluid to the FPAS 258 (FIG. 2) for actuating the one or more actuators 259 (FIG. 2) to pitch the fan blades 254 (FIG. 2) about their respective pitch axis P. The FPAS hydraulic fluid system 470 includes one or more FPAS hydraulic fluid supply lines 472 for supplying the hydraulic fluid to the FPAS 258. The one or more FPAS hydraulic fluid supply lines 472 can include the first, second, third, fourth, and fifth FPAS hydraulic fluid supply lines detailed above with respect to FIG. 3D. The FPAS hydraulic fluid system 470 can include one or more hydraulic fluid tanks for storing hydraulic fluid therein and one or more hydraulic fluid pumps for pressurizing and pumping the lubricant from the hydraulic fluid tanks to the FPAS 258 through the one or more FPAS hydraulic fluid supply lines 472. The one or more FPAS hydraulic fluid supply lines 472 extend through first stage gear assembly 404 and the second stage gear assembly 430 and are in fluid communication with the one or more actuators 259 of the FPAS 258 for supplying the hydraulic fluid to the one or more actuators 259 to actuate the actuators 259 and to change the pitch of the fan blades 254. In particular, the one or more FPAS hydraulic fluid supply lines 472 extend through the first stage planet carrier 412, through the interstage shaft 416, through the second stage sun gear 432, and through the second stage planet carrier 438. In this way, the one or more FPAS hydraulic fluid supply lines 472 extend through the clockwise gearbox assembly 400 (e.g., through the clockwise gearbox casing 402) from an input side of the clockwise gearbox assembly 400 to an output side of the clockwise gearbox assembly 400 and extend to the one or more actuators 259. The input side is an axial side of the clockwise gearbox assembly 400 through which the input shaft 314 extends, and the output side is an axial side of the clockwise gearbox assembly 400 through which the output shaft 440 extends.

In operation, the input shaft 414 (e.g., the LP shaft 238) rotates and transfers torque to the output shaft 440 through the first stage gear assembly 404 and the second stage gear assembly 430. In particular, the input shaft 414 transfers the torque to the first stage sun gear 406, causing the first stage sun gear 406 to rotate. The input shaft 414 and the first stage sun gear 406 rotate in the counterclockwise direction. The first stage sun gear 406 transfers the torque to the plurality of first stage planet gears 408 and drives the plurality of first stage planet gears 408 such that each first stage planet gear 408 rotates about the first stage planet gear longitudinal axis 415. The plurality of first stage planet gears 408 rotates in the clockwise direction (e.g., in a direction opposite of the first stage sun gear 406). The first stage planet carrier 412 holds the plurality of first stage planet gears 408 stationary with respect to the longitudinal centerline axis 212. The plurality of first stage planet gears 408 transfers the torque to the first stage ring gear 410 and drives the first stage ring gear 410 such that the first stage ring gear 410 rotates, thereby causing the interstage shaft 416 to rotate. The first stage ring gear 410 (and the interstage shaft 416) rotates in the counterclockwise direction such that the first stage ring gear 410 rotates in the same direction as the first stage sun gear 406.

The first stage ring gear 410 transfers the torque to the second stage sun gear 432 through the interstage shaft 416, causing the second stage sun gear 432 to rotate. The second stage sun gear 432 rotates in the counterclockwise direction. The second stage sun gear 432 transfers the torque to the plurality of second stage planet gears 434 and the second stage planet carrier 438, and drives the plurality of second stage planet gears 434 such that each second stage planet gear 434 rotates about the second stage planet gear longitudinal axis 443. This also causes the second stage planet carrier 438 to rotate about the longitudinal centerline axis 212 such that the plurality of second stage planet gears 434 rotates about the longitudinal centerline axis 212. The plurality of second stage planet gears 434 and the second stage planet carrier 438 rotate in the clockwise direction (e.g., in a direction opposite of the second stage sun gear 432). The second stage ring gear 436 applies a reaction torque against the plurality of second stage planet gears 434 such that the plurality of second stage planet gears 434 rotates about the second stage ring gear 436 while the second stage ring gear 436 remains stationary. The second stage planet carrier 438 transfers the torque to the output shaft 440 such that the output shaft 440 rotates. The output shaft 440 rotates in the clockwise direction such that the output shaft 440 rotates in an opposite direction as the second stage sun gear 432. Thus, the second fan 152b (coupled to the output shaft 440) rotates in the clockwise direction.

As the clockwise gearbox assembly 400 operates, the gearbox lubrication system 450 supplies the lubricant to the first stage gear assembly 404 through the one or more gearbox lubricant supply lines 452. In particular, the one or more gearbox lubricant supply lines 452 direct the lubricant to the one or more first stage lubricant supply lines 454. The one or more first stage lubricant supply lines 454 direct the lubricant to at least one of the one or more first stage roller bearings 422 or the first stage gears (the first stage sun gear 406, the plurality of first stage planet gears 408, and the first stage ring gear 410) to lubricate the one or more first stage roller bearings 422 or the first stage gears. The one or more gearbox lubricant supply lines 452 also direct the lubricant to the interstage lubricant supply line 456. The interstage lubricant supply line 456 directs the lubricant to the one or more second stage lubricant supply lines 458 through the lubricant distributor 460 (FIG. 4C). The one or more second stage lubricant supply lines 458 direct the lubricant to at least one of the one or more second stage roller bearings 444 or the second stage gears (the second stage sun gear 432, the plurality of second stage planet gears 434, and the second stage ring gear 436) to lubricate the one or more second stage roller bearings 444 or the first stage gears.

As the second turbofan engine 110b operates, the FPAS hydraulic fluid system 470 supplies the hydraulic fluid to the FPAS 258 (FIG. 2) to actuate the fan blades 254 (FIG. 2). In particular, the one or more FPAS hydraulic fluid supply lines 472 direct the hydraulic fluid to the one or more actuators 259 (FIG. 2) to rotate the fan blades 254 to change the pitch angle of the fan blades 254, as detailed above with respect to FIGS. 3B and 3D.

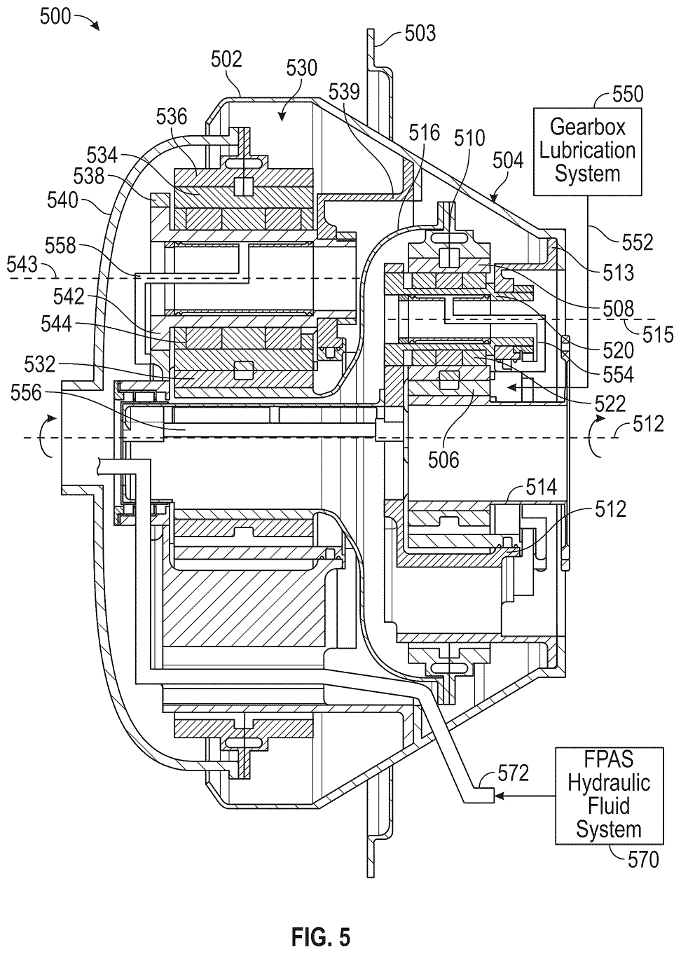

FIG. 5 is a schematic cross-sectional view of a counterclockwise gearbox assembly 500, taken along a longitudinal centerline axis of the counterclockwise gearbox assembly, according to another embodiment. The counterclockwise gearbox assembly 500 is substantially similar to the counterclockwise gearbox assembly 300 of FIGS. 3A to 3C. The same reference numerals will be used for components of the counterclockwise gearbox assembly 500 that are the same as or similar to the components of the counterclockwise gearbox assembly 300 discussed above. The description of these components above also applies to this embodiment, and a detailed description of these components is omitted here.

The first turbofan engine 110a (FIG. 1) includes a fan pitch actuation system (FPAS) hydraulic fluid system 570 for supplying the hydraulic fluid to the FPAS 258 (FIG. 2) for actuating the one or more actuators 259 (FIG. 2) to pitch the fan blades 254 (FIG. 2) about their respective pitch axis P. The FPAS hydraulic fluid system 570 includes one or more FPAS hydraulic fluid supply lines 572 for supplying the hydraulic fluid to the FPAS 258. The one or more FPAS hydraulic fluid supply lines 572 extend through the gearbox casing 302 and the second stage gear assembly 330 and are in fluid communication with the one or more actuators 259 of the FPAS 258 for supplying the hydraulic fluid to the one or more actuators 259 to actuate the actuators 259 and to change the pitch of the fan blades 254. In particular, the one or more FPAS hydraulic fluid supply lines 572 extend through the counterclockwise gearbox coupling 303 of the gearbox casing 302, and through the second stage planet carrier 338. In this way, the one or more FPAS hydraulic fluid supply lines 572 extend through the counterclockwise gearbox assembly 500 (e.g., through the counterclockwise gearbox casing 302) from an input side of the counterclockwise gearbox assembly 500 to an output side of the counterclockwise gearbox assembly 500 and extend to the one or more actuators 259.

Accordingly, the turbofan engines herein are counter-rotating in which the fan of the first turbofan engine rotates in the counterclockwise direction and the fan of the second turbofan engine rotates in the clockwise direction. Such a configuration allows both turbofan engines to have the same input rotational direction (e.g., counterclockwise) while having different output rotational directions (e.g., counterclockwise on one engine and clockwise on the other engine). The double gearbox configuration of the present disclosure provides for reducing a radial envelope (radial extent) of the gearbox assembly as compared to gearbox assemblies that achieve a particular output rotational direction by other means, such as, for example, the use of idler gears. In this way, the double gearbox configuration of the present disclosure helps to maximize a size of the core flowpath of the turbine engine as compared to turbine engines without the benefit of the present disclosure. Further, the engine system of the present disclosure reduces the fuel burn and noise as compared to the asymmetric configuration. Further, the star configuration of the first stage gear assembly (stationary planet gears) allows the fan pitch actuation system supply lines to be routed through the gearbox assembly (through the planet carrier of the first stage gear assembly) to fit within the available space of the turbofan engine. Further, the gearbox assemblies achieve a gear ratio less than or equal to 14:1 (e.g., 6:1 to 14:1) by using the star configuration, which allows for larger planet gears as compared to the planetary configuration of turboprop engines to withstand the higher loads and the higher torques as compared to turboprop engines.

Further aspects of the present disclosure are provided by the subject matter of the following clauses.

An engine system for an aircraft comprises a first turbofan engine including a first turbo-engine having a first low-pressure shaft, a first fan having a first fan shaft, and a counterclockwise gearbox assembly, the first fan shaft being drivingly coupled to the first low-pressure shaft through the counterclockwise gearbox assembly, the first low-pressure shaft rotating in a counterclockwise direction and the first fan shaft rotates in the counterclockwise direction such that the first fan rotates in the counterclockwise direction, and a second turbofan engine including a second turbo-engine having a second low-pressure shaft, a second fan having a second fan shaft, and a clockwise gearbox assembly, the second fan shaft being drivingly coupled to the second low-pressure shaft through the clockwise gearbox assembly, the second low-pressure shaft rotating in the counterclockwise direction and the second fan shaft rotates in a clockwise direction such that the second fan rotates in the clockwise direction.

The engine system of the preceding clause, the counterclockwise gearbox assembly and the clockwise gearbox assembly each having a gear ratio in a range of 6:1 to 14:1.

The engine system of any preceding clause, the counterclockwise gearbox assembly including a counterclockwise gearbox casing, and a first stage gear assembly and a second stage gear assembly disposed within the counterclockwise gearbox casing.

The engine system of any preceding clause, the first low-pressure shaft being drivingly coupled to the first stage gear assembly, and the first fan shaft is drivingly coupled to the second stage gear assembly.

The engine system of any preceding clause, the counterclockwise gearbox assembly including an interstage shaft coupled to the first stage gear assembly and the second stage gear assembly, the interstage shaft being an output of the first stage gear assembly and an input of the second stage gear assembly.

The engine system of any preceding clause, the first stage gear assembly including a first stage sun gear, a plurality of first stage planet gears, and a first stage ring gear, the first low-pressure shaft being coupled to the first stage sun gear such that the first low-pressure shaft and the first stage sun gear rotate in the counterclockwise direction, and the interstage shaft being coupled to the first stage ring gear such that the first stage ring gear and the interstage shaft rotate in the counterclockwise direction.

The engine system of any preceding clause, the second stage gear assembly including a second stage sun gear, a plurality of second stage planet gears, and a second stage ring gear, the interstage shaft being coupled to the second stage sun gear such that the second stage sun gear rotates in the counterclockwise direction, and the first fan shaft being coupled to the second stage ring gear such that the second stage ring gear and the first fan shaft rotate in the counterclockwise direction.

The engine system of any preceding clause, the first turbofan engine including a gearbox lubrication system for supplying a lubricant to the counterclockwise gearbox assembly, the gearbox lubrication system having an interstage lubricant supply line that directs the lubricant from the first stage gear assembly to the second stage gear assembly.

The engine system of any preceding clause, the first turbofan engine including a fan pitch actuation system for changing a pitch angle of a plurality of fan blades of the first fan, and a fan pitch actuation system hydraulic fluid system for supplying a hydraulic fluid to the fan pitch actuation system to change the pitch angle, the fan pitch actuation system hydraulic fluid system including one or more fan pitch actuation system hydraulic fluid supply lines that extend through the first stage gear assembly and the second stage gear assembly, the one or more fan pitch actuation system hydraulic fluid supply lines directing the hydraulic fluid to the fan pitch actuation system.

The engine system of any preceding clause, the clockwise gearbox assembly including a clockwise gearbox casing, and a first stage gear assembly and a second stage gear assembly disposed within the clockwise gearbox casing.

The engine system of any preceding clause, the second low-pressure shaft being drivingly coupled to the first stage gear assembly, and the second fan shaft is drivingly coupled to the second stage gear assembly.

The engine system of any preceding clause, the clockwise gearbox assembly including an interstage shaft coupled to the first stage gear assembly and the second stage gear assembly, the interstage shaft being an output of the first stage gear assembly and an input of the second stage gear assembly.

The engine system of any preceding clause, the first stage gear assembly including a first stage sun gear, a plurality of first stage planet gears, and a first stage ring gear, the second low-pressure shaft being coupled to the first stage sun gear such that the second low-pressure shaft and the first stage sun gear rotate in the counterclockwise direction, and the interstage shaft being coupled to the first stage ring gear such that the first stage ring gear and the interstage shaft rotate in the counterclockwise direction.

The engine system of any preceding clause, the second stage gear assembly including a second stage sun gear, a plurality of second stage planet gears constrained by a second stage planet carrier, and a second stage ring gear, the interstage shaft being coupled to the second stage sun gear such that the second stage sun gear rotates in the counterclockwise direction, and the second fan shaft being coupled to the second stage planet carrier such that the second stage planet carrier and the second fan shaft rotate in the clockwise direction.

The engine system of any preceding clause, the second turbofan engine including a gearbox lubrication system for supplying a lubricant to the clockwise gearbox assembly, the gearbox lubrication system having an interstage lubricant supply line that directs the lubricant from the first stage gear assembly to the second stage gear assembly.

The engine system of any preceding clause, the second turbofan engine including a fan pitch actuation system for changing a pitch angle of a plurality of fan blades of the second fan, and a fan pitch actuation system hydraulic fluid system for supplying a hydraulic fluid to the fan pitch actuation system to change the pitch angle, the fan pitch actuation system hydraulic fluid system including one or more fan pitch actuation system hydraulic fluid supply lines that extend through the first stage gear assembly and the second stage gear assembly, the one or more fan pitch actuation system hydraulic fluid supply lines directing the hydraulic fluid to the fan pitch actuation system.

An engine system for an aircraft comprises a turbofan engine including a turbo-engine having a low-pressure shaft, a fan having a fan shaft, and a counterclockwise gearbox assembly having a gear ratio in a range of 6:1 to 14:1, the counterclockwise gearbox assembly comprising a counterclockwise gearbox casing, a first stage gear assembly and a second stage gear assembly disposed within the counterclockwise gearbox casing, and an interstage shaft coupled to the first stage gear assembly and the second stage gear assembly, the interstage shaft being an output of the first stage gear assembly and an input of the second stage gear assembly, the first stage gear assembly comprising a first stage sun gear, a plurality of first stage planet gears, and a first stage ring gear, the low-pressure shaft being coupled to the first stage sun gear such that the low-pressure shaft and the first stage sun gear rotate in a counterclockwise direction, and the interstage shaft being coupled to the first stage ring gear such that the first stage ring gear and the interstage shaft rotate in the counterclockwise direction, the second stage gear assembly comprising a second stage sun gear, a plurality of second stage planet gears, and a second stage ring gear, the interstage shaft being coupled to the second stage sun gear such that the second stage sun gear rotates in the counterclockwise direction, and the fan shaft being coupled to the second stage ring gear such that the second stage ring gear and the fan shaft rotate in the counterclockwise direction.

The engine system of any preceding clause, the turbofan engine including a fan pitch actuation system for changing a pitch angle of a plurality of fan blades of the fan, and a fan pitch actuation system hydraulic fluid system for supplying a hydraulic fluid to the fan pitch actuation system to change the pitch angle, the fan pitch actuation system hydraulic fluid system including one or more fan pitch actuation system hydraulic fluid supply lines that extend through the first stage gear assembly and the second stage gear assembly, the one or more fan pitch actuation system hydraulic fluid supply lines directing the hydraulic fluid to the fan pitch actuation system.

An engine system for an aircraft comprises a turbofan engine including a turbo-engine having a low-pressure shaft, a fan having a fan shaft, and a clockwise gearbox assembly having a gear ratio in a range of 6:1 to 14:1, the clockwise gearbox assembly comprising a clockwise gearbox casing, a first stage gear assembly and a second stage gear assembly disposed within the clockwise gearbox casing, and an interstage shaft coupled to the first stage gear assembly and the second stage gear assembly, the interstage shaft being an output of the first stage gear assembly and an input of the second stage gear assembly, the first stage gear assembly comprising a first stage sun gear, a plurality of first stage planet gears, and a first stage ring gear, the low-pressure shaft being coupled to the first stage sun gear such that the low-pressure shaft and the first stage sun gear rotate in a counterclockwise direction, and the interstage shaft being coupled to the first stage ring gear such that the first stage ring gear and the interstage shaft rotate in the counterclockwise direction, the second stage gear assembly comprising, a second stage sun gear, a plurality of second stage planet gears constrained by a second stage planet carrier, and a second stage ring gear, the interstage shaft being coupled to the second stage sun gear such that the second stage sun gear rotates in the counterclockwise direction, and the fan shaft being coupled to the second stage planet carrier such that the second stage planet carrier and the fan shaft rotate in a clockwise direction.

The engine system of any preceding clause, the turbofan engine including a fan pitch actuation system for changing a pitch angle of a plurality of fan blades of the fan, and a fan pitch actuation system hydraulic fluid system for supplying a hydraulic fluid to the fan pitch actuation system to change the pitch angle, the fan pitch actuation system hydraulic fluid system including one or more fan pitch actuation system hydraulic fluid supply lines that extend through the first stage gear assembly and the second stage gear assembly, the one or more fan pitch actuation system hydraulic fluid supply lines directing the hydraulic fluid to the fan pitch actuation system.

A method of operating the engine system of any preceding clause, the method comprising rotating the first low-pressure shaft in the counterclockwise direction, rotating the first fan shaft in the counterclockwise direction through the counterclockwise gearbox assembly, rotating the second low-pressure shaft in the counterclockwise direction, and rotating the second fan shaft in the clockwise direction through the clockwise gearbox assembly.

A method of operating the engine system of any preceding clause, the method comprising rotating the low-pressure shaft and the first stage sun gear in the counterclockwise direction, rotating the interstage shaft, the first stage ring gear, and the second stage sun gear in the counterclockwise direction through the first stage gear assembly, and rotating the second stage ring gear and the fan shaft in the counterclockwise direction through the second stage gear assembly.

A method of operating the engine system of any preceding clause, the method comprising rotating the low-pressure shaft and the first stage sun gear in the counterclockwise direction, rotating the interstage shaft, the first stage ring gear, and the second stage sun gear in the counterclockwise direction through the first stage gear assembly, and rotating the second stage planet carrier and the fan shaft in the clockwise direction through the second stage gear assembly.

The method of any preceding clause, further comprising directing the lubricant from the first stage gear assembly to the second stage gear assembly through the interstage lubricant supply line.

The method of any preceding clause, further comprising directing a hydraulic fluid to the fan pitch actuation system through the one or more fan pitch actuation system hydraulic fluid supply lines through the first stage gear assembly and the second stage gear assembly.

Although the foregoing description is directed to the preferred embodiments of the present disclosure, other variations and modifications will be apparent to those skilled in the art and may be made without departing from the disclosure. Moreover, features described in connection with one embodiment of the present disclosure may be used in conjunction with other embodiments, even if not explicitly stated above.

1. An engine system for an aircraft, the engine system comprising:
a first turbofan engine including:
a first turbo-engine having a first low-pressure shaft;
a first fan having a first fan shaft; and
a counterclockwise gearbox assembly, the first fan shaft being drivingly coupled to the first low-pressure shaft through the counterclockwise gearbox assembly, wherein the first low-pressure shaft rotates in a counterclockwise direction and the first fan shaft rotates in the counterclockwise direction such that the first fan rotates in the counterclockwise direction; and
a second turbofan engine including:
a second turbo-engine having a second low-pressure shaft;
a second fan having a second fan shaft; and
a clockwise gearbox assembly, the second fan shaft being drivingly coupled to the second low-pressure shaft through the clockwise gearbox assembly, wherein the second low-pressure shaft rotates in the counterclockwise direction and the second fan shaft rotates in a clockwise direction such that the second fan rotates in the clockwise direction.

2. The engine system of claim 1, wherein the counterclockwise gearbox assembly and the clockwise gearbox assembly each has a gear ratio in a range of 6:1 to 14:1.

3. The engine system of claim 1, wherein the counterclockwise gearbox assembly includes a counterclockwise gearbox casing, and a first stage gear assembly and a second stage gear assembly disposed within the counterclockwise gearbox casing.

4. The engine system of claim 3, wherein the first low-pressure shaft is drivingly coupled to the first stage gear assembly, and the first fan shaft is drivingly coupled to the second stage gear assembly.

5. The engine system of claim 4, wherein the counterclockwise gearbox assembly includes an interstage shaft coupled to the first stage gear assembly and the second stage gear assembly, the interstage shaft being an output of the first stage gear assembly and an input of the second stage gear assembly.

6. The engine system of claim 5, wherein the first stage gear assembly includes a first stage sun gear, a plurality of first stage planet gears, and a first stage ring gear, the first low-pressure shaft being coupled to the first stage sun gear such that the first low-pressure shaft and the first stage sun gear rotate in the counterclockwise direction, and the interstage shaft being coupled to the first stage ring gear such that the first stage ring gear and the interstage shaft rotate in the counterclockwise direction.

7. The engine system of claim 6, wherein the second stage gear assembly includes a second stage sun gear, a plurality of second stage planet gears, and a second stage ring gear, the interstage shaft being coupled to the second stage sun gear such that the second stage sun gear rotates in the counterclockwise direction, and the first fan shaft being coupled to the second stage ring gear such that the second stage ring gear and the first fan shaft rotate in the counterclockwise direction.

8. The engine system of claim 7, wherein the first turbofan engine includes a gearbox lubrication system for supplying a lubricant to the counterclockwise gearbox assembly, the gearbox lubrication system having an interstage lubricant supply line that directs the lubricant from the first stage gear assembly to the second stage gear assembly.

9. The engine system of claim 7, wherein the first turbofan engine includes a fan pitch actuation system for changing a pitch angle of a plurality of fan blades of the first fan, and a fan pitch actuation system hydraulic fluid system for supplying a hydraulic fluid to the fan pitch actuation system to change the pitch angle, the fan pitch actuation system hydraulic fluid system including one or more fan pitch actuation system hydraulic fluid supply lines that extend through the first stage gear assembly and the second stage gear assembly, the one or more fan pitch actuation system hydraulic fluid supply lines directing the hydraulic fluid to the fan pitch actuation system.

10. The engine system of claim 1, wherein the clockwise gearbox assembly includes a clockwise gearbox casing, and a first stage gear assembly and a second stage gear assembly disposed within the clockwise gearbox casing.

11. The engine system of claim 10, wherein the second low-pressure shaft is drivingly coupled to the first stage gear assembly, and the second fan shaft is drivingly coupled to the second stage gear assembly.

12. The engine system of claim 11, wherein the clockwise gearbox assembly includes an interstage shaft coupled to the first stage gear assembly and the second stage gear assembly, the interstage shaft being an output of the first stage gear assembly and an input of the second stage gear assembly.

13. The engine system of claim 12, wherein the first stage gear assembly includes a first stage sun gear, a plurality of first stage planet gears, and a first stage ring gear, the second low-pressure shaft being coupled to the first stage sun gear such that the second low-pressure shaft and the first stage sun gear rotate in the counterclockwise direction, and the interstage shaft being coupled to the first stage ring gear such that the first stage ring gear and the interstage shaft rotate in the counterclockwise direction.

14. The engine system of claim 13, wherein the second stage gear assembly includes a second stage sun gear, a plurality of second stage planet gears constrained by a second stage planet carrier, and a second stage ring gear, the interstage shaft being coupled to the second stage sun gear such that the second stage sun gear rotates in the counterclockwise direction, and the second fan shaft being coupled to the second stage planet carrier such that the second stage planet carrier and the second fan shaft rotate in the clockwise direction.

15. The engine system of claim 14, wherein the second turbofan engine includes a gearbox lubrication system for supplying a lubricant to the clockwise gearbox assembly, the gearbox lubrication system having an interstage lubricant supply line that directs the lubricant from the first stage gear assembly to the second stage gear assembly.

16. The engine system of claim 14, wherein the second turbofan engine includes a fan pitch actuation system for changing a pitch angle of a plurality of fan blades of the second fan, and a fan pitch actuation system hydraulic fluid system for supplying a hydraulic fluid to the fan pitch actuation system to change the pitch angle, the fan pitch actuation system hydraulic fluid system including one or more fan pitch actuation system hydraulic fluid supply lines that extend through the first stage gear assembly and the second stage gear assembly, the one or more fan pitch actuation system hydraulic fluid supply lines directing the hydraulic fluid to the fan pitch actuation system.

17. An engine system for an aircraft, the engine system comprising:
a turbofan engine including a turbo-engine having a low-pressure shaft, a fan having a fan shaft, and a counterclockwise gearbox assembly having a gear ratio in a range of 6:1 to 14:1, the counterclockwise gearbox assembly comprising:
a counterclockwise gearbox casing;
a first stage gear assembly and a second stage gear assembly disposed within the counterclockwise gearbox casing; and
an interstage shaft coupled to the first stage gear assembly and the second stage gear assembly, the interstage shaft being an output of the first stage gear assembly and an input of the second stage gear assembly,
the first stage gear assembly comprising:
a first stage sun gear;
a plurality of first stage planet gears; and
a first stage ring gear, the low-pressure shaft being coupled to the first stage sun gear such that the low-pressure shaft and the first stage sun gear rotate in a counterclockwise direction, and the interstage shaft being coupled to the first stage ring gear such that the first stage ring gear and the interstage shaft rotate in the counterclockwise direction,
the second stage gear assembly comprising:
a second stage sun gear;
a plurality of second stage planet gears; and
a second stage ring gear, the interstage shaft being coupled to the second stage sun gear such that the second stage sun gear rotates in the counterclockwise direction, and the fan shaft being coupled to the second stage ring gear such that the second stage ring gear and the fan shaft rotate in the counterclockwise direction.

18. The engine system of claim 17, wherein the turbofan engine includes a fan pitch actuation system for changing a pitch angle of a plurality of fan blades of the fan, and a fan pitch actuation system hydraulic fluid system for supplying a hydraulic fluid to the fan pitch actuation system to change the pitch angle, the fan pitch actuation system hydraulic fluid system including one or more fan pitch actuation system hydraulic fluid supply lines that extend through the first stage gear assembly and the second stage gear assembly, the one or more fan pitch actuation system hydraulic fluid supply lines directing the hydraulic fluid to the fan pitch actuation system.

19. An engine system for an aircraft, the engine system comprising:
a turbofan engine including a turbo-engine having a low-pressure shaft, a fan having a fan shaft, and a clockwise gearbox assembly having a gear ratio in a range of 6:1 to 14:1, the clockwise gearbox assembly comprising:
a clockwise gearbox casing;
a first stage gear assembly and a second stage gear assembly disposed within the clockwise gearbox casing; and
an interstage shaft coupled to the first stage gear assembly and the second stage gear assembly, the interstage shaft being an output of the first stage gear assembly and an input of the second stage gear assembly,
the first stage gear assembly comprising:
a first stage sun gear;
a plurality of first stage planet gears; and
a first stage ring gear, the low-pressure shaft being coupled to the first stage sun gear such that the low-pressure shaft and the first stage sun gear rotate in a counterclockwise direction, and the interstage shaft being coupled to the first stage ring gear such that the first stage ring gear and the interstage shaft rotate in the counterclockwise direction,
the second stage gear assembly comprising:
a second stage sun gear;
a plurality of second stage planet gears constrained by a second stage planet carrier; and
a second stage ring gear, the interstage shaft being coupled to the second stage sun gear such that the second stage sun gear rotates in the counterclockwise direction, and the fan shaft being coupled to the second stage planet carrier such that the second stage planet carrier and the fan shaft rotate in a clockwise direction.

20. The engine system of claim 19, wherein the turbofan engine includes a fan pitch actuation system for changing a pitch angle of a plurality of fan blades of the fan, and a fan pitch actuation system hydraulic fluid system for supplying a hydraulic fluid to the fan pitch actuation system to change the pitch angle, the fan pitch actuation system hydraulic fluid system including one or more fan pitch actuation system hydraulic fluid supply lines that extend through the first stage gear assembly and the second stage gear assembly, the one or more fan pitch actuation system hydraulic fluid supply lines directing the hydraulic fluid to the fan pitch actuation system.
